(19) United States
(12) Patent Application Publication
(10) Pub. No.: US 2001/0051890 A1
(43) Pub. Date: Dec. 13, 2001

(54) Systems and methods for providing remote support via productivity centers

(76) Inventor: Raleigh Burgess, Roswell, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/813,663

(22) Filed: Mar. 19, 2001

Related U.S. Application Data
(60) Provisional application No. 60/190,390, filed on Mar. 17, 2000.
(60) Provisional application No. 60/190,412, filed on Mar. 17, 2000.

(51) Int. Cl. G06F 17/60

(52) U.S. Cl. 705/9

(57) ABSTRACT

A productivity center provides remote support directly and indirectly to one or more monitored systems. The productivity center receives data on the operating system, database, and applications, such as SAP Basis, and determines if any jobs need to be performed. The productivity center optimizes resources by automatically performing some of the jobs and then allocating other jobs to associates based on their skill levels. A scheduling algorithm factors in the associate's skill level, time needed to perform the job, the required completion time, the associate availability, and other factors to optimize use of the associates time. The productivity center provides status information on the monitored systems and provides alerts and notifications to clients on the status of the monitored system.

### RELATED APPLICATIONS

This application claims priority to, and incorporates by reference, co-pending provisional patent application Serial No. 60/190,390 entitled “Out-Tasking Support System,” and co-pending provisional patent application Serial No. 60/190,412, entitled “Scheduling Algorithm,” both filed on Mar. 17, 2000.

### FIELD OF THE INVENTION

The invention generally relates to systems and methods for providing remote support for information systems and, more particularly, relates to systems and methods for providing remote productivity centers that automate support and also optimizes reliance on personnel in providing other support.

### BACKGROUND

Our society in general, and especially the business world, is becoming increasingly dependent and reliant on technology. No longer are we content to simply use the telephone and facsimile machine to communicate with each other, but now we turn to email to not only exchange messages but also documents and other files. Pagers, mobile radiotelephones, and personnel digital assistants (PDAs) are also commonly used and are being integrated into existing applications and networks. The networks that are deployed within businesses are becoming more complex and have grown considerably over the years. The networks not only consist of local area networks, such as within a business, but also encompass Wide Area Networks (WANs), Virtual Private Networks (VPNs), intranets, and the Internet. These networks have also seen growth in the number of applications that must be supported and also in the amount of data that must be available to the users.

As can be appreciated by those skilled in the art, many organizations require substantial support for their information technology (IT) systems. IT support, for example, encompasses maintaining, over-seeing, trouble-shooting, developing applications, and coordinating with vendors and other third parties. This IT support covers a wide variety of tasks, from interconnections to other systems or networks, such as internet connections, ATM connections, frame relay connections, and telephonic connections, on operating systems at both the server and client sides, database support, and support for applications running on the network or locally at any client. Because of the broad spectrum of tasks that may be performed through an IT support team, IT support can be a burden even for a relatively small network and can be quite onerous for larger networks and organizations.

In light of the IT support needed, organizations frequently employ a staff of personnel whose sole job is to provide the IT support. Because of a high demand for such personnel, organizations often cannot find experienced personnel and thus need to hire people and provide some on the job training to help them perform their jobs. Once an employee receives this training and experience, the employee is often enticed to join another organization paying a higher salary. The organization is then again faced with hiring additional people and providing them with the necessary training. This paradigm causes high turnover/recruiting costs.

Another approach in providing support is by out-sourcing these jobs to an outside firm. These consulting firms also suffer from a shortage of experienced professionals which means that the organization may still have IT support which is learning on the job and not well-qualified to do the assigned task. Additionally, consulting firms service a large number of clients which means that they may not be able to provide service and support as quickly as an organization needs or desires such support. The consultants, especially independent consultants, can be expensive yet provide no promise of quality or any assurance that the support is provided in a timely or an efficient manner. Outsourcing also provides an “all or nothing” choice which many IT shops are not ready to make. Therefore, while out-sourcing IT support is an option, out-sourcing IT support suffers from some of the same problems as in-house IT support as well as some unique problems of its own.

To illustrate the problems in providing IT support, a description will now be given with reference to providing support for software available through SAP of Walldorf, Germany. SAP provides enterprise resource planning (ERP) software which is installed in over 40 countries around the world and is the software of choice for twenty-five percent of the Fortune 500. SAP provides mySAP.com™ which is a comprehensive e-business platform that supports databases, applications, operating systems, and hardware platforms from almost any major vendor. SAP also provides a number of e-business solutions that are supported by the mySAP.com™ platform. SAP Basis is a software component that provides the underlying technology for all of the mySAP.com™ application component and solutions. SAP Basis is therefore an insulating middleware that sits between the SAP application modules and the operating system.

A considerable amount of technical support resources are required to install, manage, and maintain SAP Basis. Research indicates that installing, managing, and maintaining basis requires twenty percent of the total technical resources required during the typical SAP lifecycle, including implementation and production system support. Additional technical support resources required over the SAP lifecycle include thirty percent of total resources needed for Advanced Business Applications Programming (ABAP) efforts and fifty percent of total resources needed for functional configuration and user liaison efforts. Providing SAP Basis support, however, is not simply a matter of appropriating a certain fraction of the available resources. Instead, supporting SAP Basis requires an understanding of the types of tasks that are required for a Basis project. Roughly 500 Basis tasks must be performed over the project lifecycle from implementation to “steady state” support. These tasks can be separated into skill levels with about twenty-three percent of the Basis tasks which must be performed by people with at least three years of Basis experience, thirty-one percent of tasks that must be performed by people with two years of Basis experience, and forty six percent of tasks which must be performed by people with at least a year of Basis experience. Considering that almost sixty-five percent of all tasks performed by an in-house IT department are Basis related, with twenty-four percent being operating system related and eleven percent being database activities related, SAP Basis support clearly requires significant resources of an organization.

The difficulty in finding and maintaining the proper level of support is especially true with SAP Basis support. The United States has only about five thousand professionals with Basis experience and is facing a shortage of personnel with appropriate skills. An organization therefore has a difficult time finding and keeping Basis technicians in a demand-driven environment. Organizations are seeing high turnover and high salaries for employees having Basis and other technical skills. These challenges are not unique to in-house IT teams but are also felt by consulting firms and other consultants.

Again, the challenges facing an organization in providing quality support is not specific to SAP Basis or even SAP, but is also felt in providing support for operating systems, databases, and other aspects of an organizations information technology.

### SUMMARY

The invention addresses the problems described above by providing systems and methods for providing remote support to a monitored system. According to one aspect, a productivity center according to the invention receives data from the monitored system and this data may comprise performance data on the operating system, database, or applications, such as SAP Basis. The productivity center may also receive other types of data, such as alerts, notifications, and messages. The productivity center processes the data and determines any jobs that need to be performed. The productivity center attempts to perform as many jobs as possible automatically without requiring the direct input from an associate. For work that must be performed manually, the productivity center optimizes use of the personnel. In the preferred embodiment, the productivity center 10 considers the difficulty in performing a job, skill levels of associates, assignments of associates to clients, time required to perform a job, the time when a job must be completed, the availability of associates, and the work load of the associates in allocating the jobs. By optimizing use of the productivity center itself in performing jobs and in efficiently distributing jobs to the associates, the total cost in supporting a monitored system can be substantially reduced because of the automation.

The preferred productivity center according to the invention includes a message-oriented middleware for asynchronously exchanging messages with the monitored system. The data exchange between the productivity center and the monitored system is preferably in XML. The productivity center has a message broker for receiving the data from the monitored system and for routing it to the appropriate component within the center. The solution engine within the productivity center receives new jobs and schedules the jobs to an associate or to a scheduling engine, which automatically performs the job. In scheduling the job, the solution engine pulls data from a task dictionary and associate calendar and then determines the optimal assignment for that job. The productivity center also includes an escalation engine which sends alerts and notifications to appropriate personnel. For example, the escalation engine can send e-mails or page associates or the client to alert them of parameter threshold being exceeded or to alert them of a job which needs completed.

The productivity center provides a number of interfaces or cockpits through which users can interface with the center. One of these cockpits is an associate cockpit through which an associate can review his or her work queue, select an open job to work on, and then close jobs after the work has been completed.

The monitored system includes probes or agents for gathering data and sending it to the productivity center. These agents measure a number of parameters at the monitored system and send the measurements over to the productivity center. The agents also perform tasks as instructed by the productivity center. The probes are preferably placed on every server within the monitored system and, potentially, can be placed on other devices or elements within the system.

### BRIEF DESCRIPTION OF DRAWINGS

The accompanying drawings, which are incorporated in and form a part of the specification, illustrate preferred embodiments of the present invention and, together with the description, disclose the principles of the invention. In the drawings:

FIG. 1 is a block diagram of a network according to a preferred embodiment of the invention;

FIG. 2 is a preferred method of operation for the productivity center of FIG. 1;

FIG. 3 is an overall architecture of the network in FIG. 1;

FIG. 4 is a more detailed block diagram of the productivity center and of a monitored system shown in FIG. 1;

FIG. 5 is a preferred network architecture for the productivity center;

FIG. 6 is a more detailed block diagram of a solution engine within the productivity center;

FIGS. 7(A) and 7(B) are preferred methods of operation for the solution engine;

FIGS. 8(A) and 8(B) are process flow diagrams for the solution engine;

FIG. 9 is a preferred method of performing work;

FIG. 10 is an interface providing details on a task;

FIG. 11 is an example of an interface showing a job queue;

FIG. 12 is an example of an interface showing additional job details;

FIG. 13 is a preferred wireless architecture;

FIG. 14 is an example of an interface provided on a wireless mobile radiotelephone;

FIG. 15 is an example of an interface provided on a personal digital assistant;

FIG. 16 is a more detailed diagram of a monitored system;

FIG. 17 is a process flow diagram of data being delivered to the productivity center;

FIG. 18 is a process flow diagram illustrating commands being sent from the productivity center to a monitored system;

FIG. 19 is an example of a main interface to the productivity center;

FIG. 20 is an example of a login interface to the productivity center;

FIG. 21 is an example of a CIO cockpit interface to the productivity center;

FIG. 22 is an interface that provides additional information on the overall system status;

FIG. 23 is an example of a Basis cockpit;

FIG. 24 is an example of an interface providing additional details on the SAP status;

FIG. 25 is an example of an operating system cockpit;

FIG. 26 is an interface illustrating additional details on the current Operating System status;

FIG. 27 is a graph of performance over a twenty four hour period which is available through the interface of FIG. 26;

FIG. 28 is an example of a Database cockpit;

FIG. 29 is an interface illustrating additional details available on the current Database status;

FIG. 30 is an interface to the productivity center for acquiring parameter and other reports;

FIG. 31 is an example of a Jobs interface;

FIG. 32 illustrates a job queue of unstarted jobs;

FIG. 33 illustrates an interface showing a job queue of started jobs;

FIG. 34 illustrates an interface showing job details for one of the started jobs;

FIG. 35 illustrates an interface providing task details on a job, including instructions for performing the job;

FIG. 36 illustrates an interface for creating a new job;

FIG. 37 is an interface through which a job can be created by browsing through a task categories tree; and

FIG. 38 is an interface through which a job can be created based on task ID or keyword.

### DETAILED DESCRIPTION

Reference will now be made in detail to preferred embodiments of the invention, non-limiting examples of which are illustrated in the accompanying drawings.

I. Overview

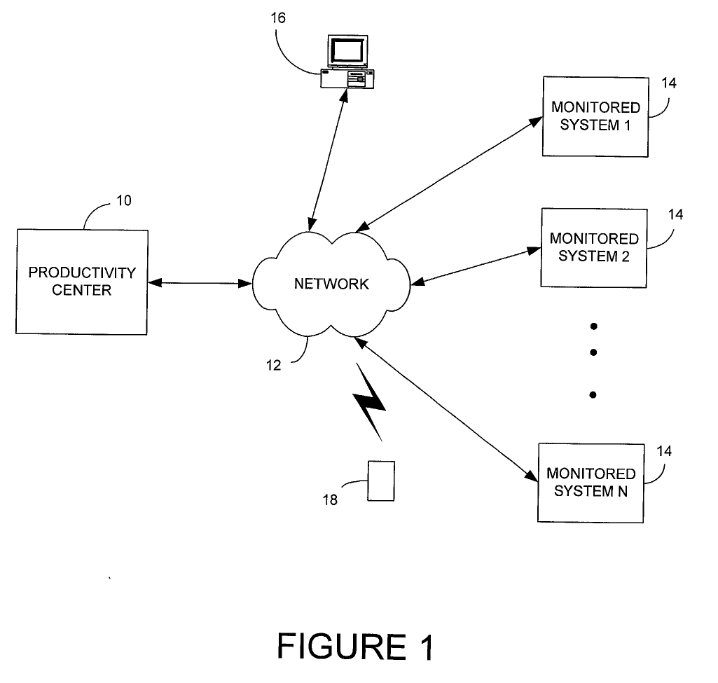

A network according to a preferred embodiment of the invention will now be described with reference to FIG. 1. A productivity center 10 according to the preferred embodiment of the invention is connected to one or more monitored systems 141 to N through a network 12. The productivity center 10 assists in the performance of tasks and also directly performs tasks related to supporting the monitored systems 14. The network also permits access to the productivity center 10 and/or monitored system 14 through a computer 16 and through a wireless device 18.

Each of the monitored systems 14 includes systems or devices that require support. For example, the monitored system 14 may include one or more servers, such as database servers, web servers, mail servers, image servers, etc. As can be appreciated from the list of exemplary servers, the invention is not limited to any specific type of server or to the functions that the server performs. In addition to servers, the monitored system 14 includes other devices, such as routers, switches, firewalls, and other hardware and software elements that can be monitored and/or supported by the productivity center 10.

The computer 16 shown in FIG. 1 is separate from either the productivity center 10 or the monitored system 14. The computer 16 can therefore go directly through the network 12 and preferably can access either the productivity center 10 or the monitored system 14. In addition to being separate from the productivity center 10 and the monitored system 14, the computer 16 preferably also represents a plurality of computers that are located within the productivity center 10 or within the monitored systems 14. The wireless device 18 includes any type of wireless device, such as, but not limited to, pagers, mobile radiotelephones, personal digital assistants (PDAs), Pocket PCs, Palm Pilot, Visor, Blackberry, Internet appliances, and other wireless data and/or communication devices.

The network 12 represents a number of different types of networks that may be encompassed by the invention. The productivity center 10 and the monitored systems 14 preferably communicate over a Virtual Private Network (VPN). The network 12 also includes the Internet as well as wireless networks and any intermediate access providers, such as Internet Service Providers (ISPs) and gateways.

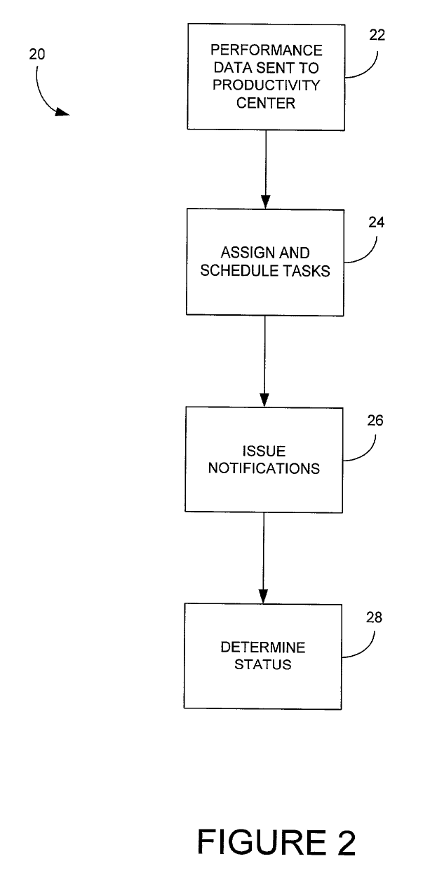

A method 20 of operation for the productivity center 10 will now be described with reference to FIG. 2. The productivity center 10 at 22 receives data from the monitored system 14. This data, as will be described in more detail below, includes performance data, events, alerts, and messages. At 24, the productivity center 10 assigns and schedules any necessary jobs. These jobs may be performed by the productivity center 10 itself or the jobs may be performed manually through an associate. The productivity center 10 advantageously automatically performs the work required of a job and only sends the job to an associate if that job requires some manual work. The productivity center 10 therefore reduces the amount of manual labor that is required in supporting the monitored systems 14.

Next, at 26, the productivity center 10 issues any notifications required due to the data received. These notifications may go to the associates, to the computers 16, to the wireless devices 18, to the monitored systems 14, or to other systems or devices. Then, at 28, the productivity center 10 determines the status of the monitored system 14. This status information, as described below, can be retrieved through the network 12 by the computer 16, wireless device 18, and within either the productivity center 10 or monitored system 14.

For the purposes of this description, an explanation will now be given on a monitored system 14 which runs SAP software. The monitored system 14 has SAP Basis running on its servers as well as one or more additional SAP modules. The productivity center 10 therefore provides remote support directly to the monitored system 14, as well as indirectly through associates, for SAP Basis. Again, while in the preferred embodiment the monitored system 14 runs SAP Basis, it will be apparent to those skilled in the art that the productivity center 10 may be used to provide support directly and indirectly to systems that do not run SAP Basis. For example, the productivity center 10 may be used with software from Commerce One, Oracle, i2 Technologies, Ariba, Broadvision, and Siebel.

II. Productivity Center

A. Architecture

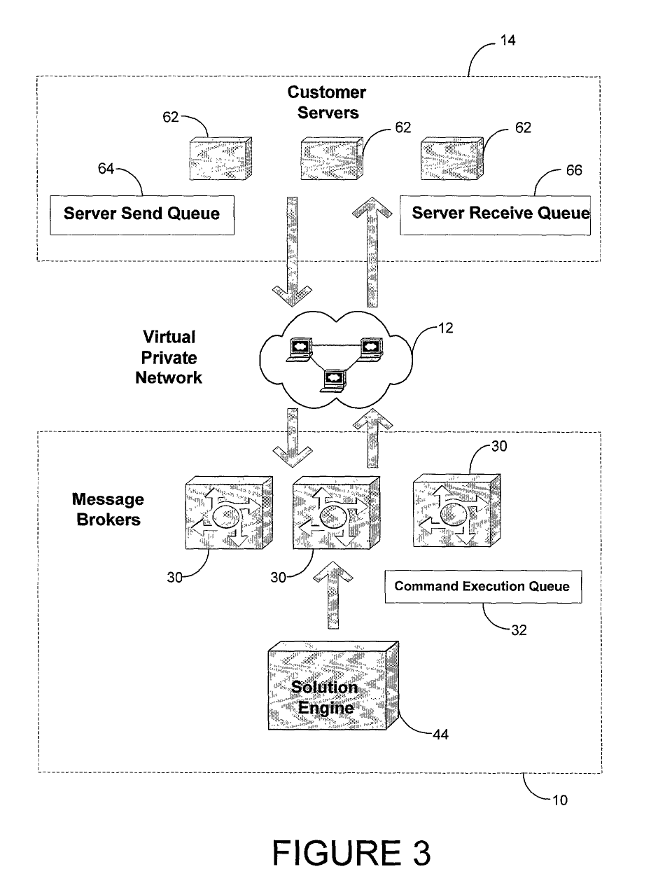

A more detailed partial block diagrams of the productivity center 10 and of the monitored system 14 are shown in FIG. 3. The monitored system 14 includes one or more servers 62 from which data is gathered and first supplied to a server send queue 64. The server send queue 64 gathers the data and sends it through the VPN 12 to the productivity center 10. The productivity center 10 includes one or more message brokers 30 for processing the incoming data. One component within the productivity center 10 is a solution engine 44 which, inter alia, assigns some jobs to associates and has other jobs worked on automatically by the productivity center 10. In processing the tasks, the productivity center 10 may send commands to the monitored system 14, with these commands first going through a command execution queue 32 within the productivity center 10 and then being placed in a server receive queue 66 within the monitored system 14.

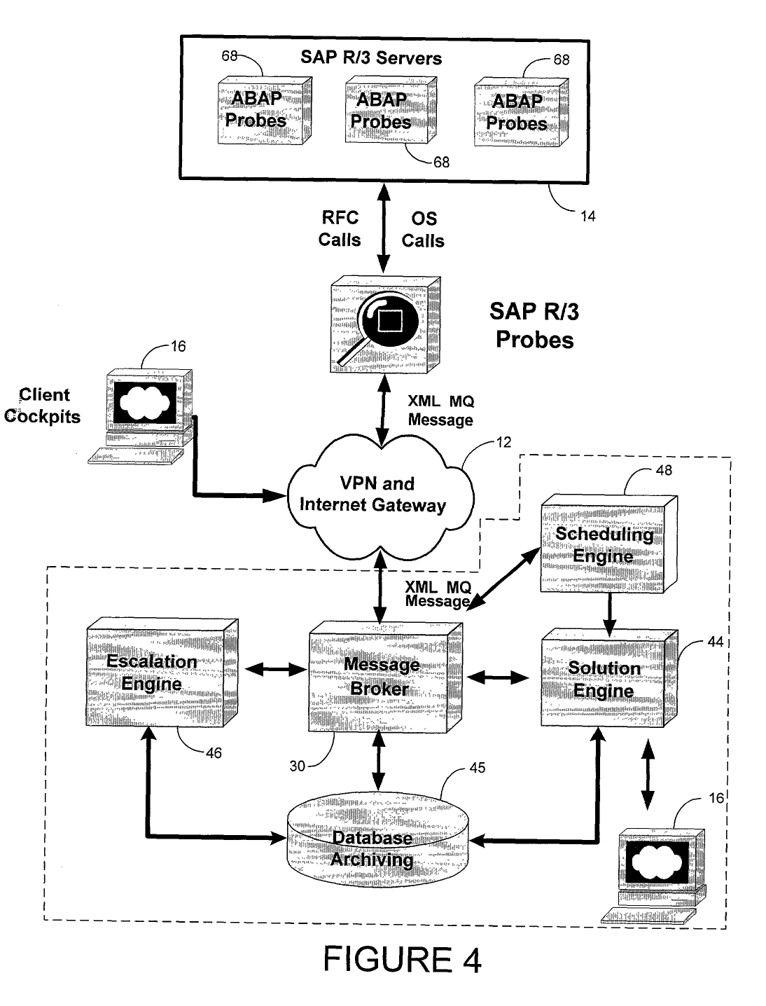

FIG. 4 illustrates partial diagrams of the productivity center 10 and the monitored system 14. As mentioned above, in the preferred embodiment, the productivity center 10 monitors systems 14 that run SAP Basis. FIG. 4 illustrates the monitored system 14 as including Advanced Business Applications Programming (ABAP) probes 68 which are placed on each of the SAP R/3 servers within the monitored system 14. These probes 68 gather data and send it through the VPN 12 to the productivity center 10. The data from the monitored system 14 goes to a message broker 30 which performs some processing of the data and also message routing. For example, the message broker stores performance data within a database 45 and sends data that requires jobs to be performed to a solution engine 44. The solution engine 44 assigns the jobs to an associate, such as to an associates computer or, if the work can be performed automatically, assigns the job to a scheduling engine 48. Additionally, some of the data may require some other action, such as sending a notification, in which the message broker 30 sends the data and/or message to an escalation engine 46. The functions and operations of the various components within the productivity center 10 will be described in more detail below.

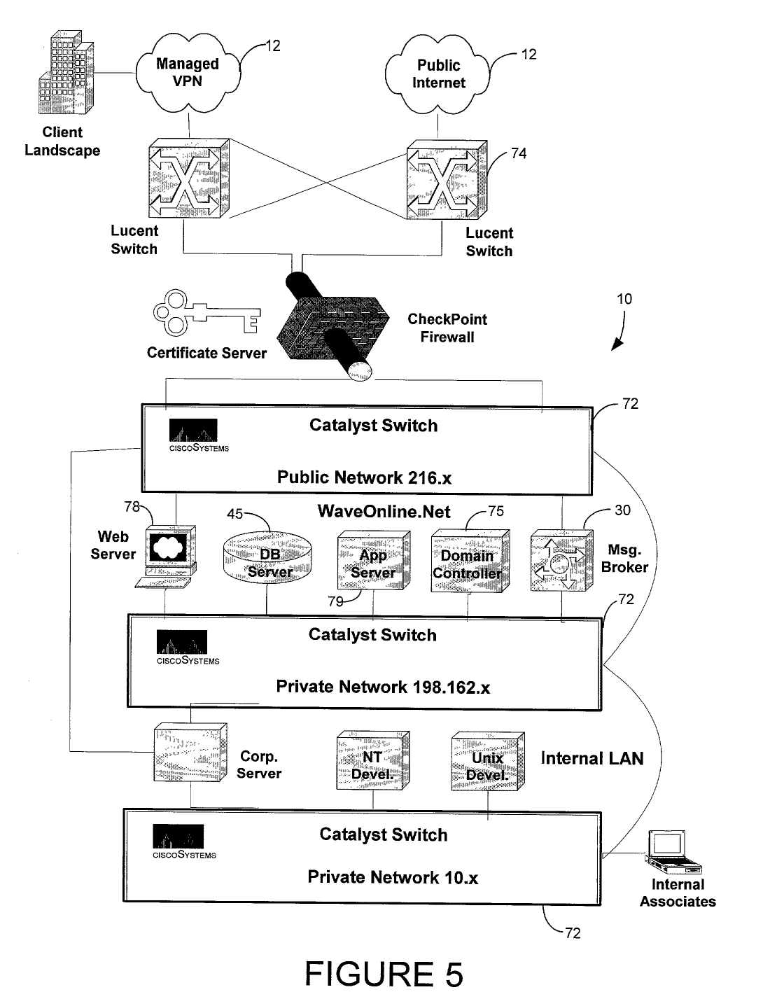

FIG. 5 illustrates an exemplary network architecture for the productivity center 10. The productivity center 10 preferably includes redundant Lucent 10/100 switches 74 interconnected using Gigabit uplink ports. All servers within the productivity center 10 are assigned static IP addresses and utilize DNS for all name resolution through a domain controller 75. A demilitarized zone (DMZ) isolates a web server farm 78 and proxy server from the public Internet 12 and the private internal LAN. A packet-based firewall is installed on a Cisco 26/10 router to filter out traffic from the Internet 12. Preferably, all traffic except TCP/IP ports for HTTP, HTPS, SMTP, MQ Series, and Outbound TelNet and FTP are prohibited. A software-based firewall, a Checkpoint Firewall-1, provides further isolation for the productivity center 10 and internal LAN. A second Cisco router 72 is used to form a subnet for a middle and back-end tier server farm and a third Cisco router 72 is used to isolate the internal LAN from the subnet.

The productivity center 10 preferably uses the best industry practices to provide the highest level of security. For example, the productivity center 10 employs digital signatures/certificates using public-private keys and uses Internet Information Server (IIS) Version 5, IPSec-based security for the VPN 12, and uses secure sockets layer (SSL) for securing all client-specific web pages.

The productivity center 10 also provides security at the application level in order to ensure the integrity of each monitored systems 14 data. The productivity center 10 includes a login screen through which a user must enter a user name and password in order to gain access to the productivity center 10. Each client associated with a monitored system 14 approves in advance any user who needs to access their data and the productivity center 10 validates each user against this pre-approved list of users. The productivity center 10 may also authenticate the user using a digital certificate if SSL is enabled for that client. The primary interface to all client data is through web-based cockpits/screens via standard internet browsers. The productivity center 10 provides specialized rule-based portal for the intended audience, such as CIO, Basis administrator, system administrator, etc. The productivity center 10 relies upon advanced security features of Cold Fusion to administer security at the cockpit level.

B. Message Broker

The message broker 30 is a watch dog agent that processes data received from the monitored system 14. The message broker 30 also processes messages sent by other components within the productivity center 10, such as the scheduling engine 48 and escalation engine 46. The message broker 30 is preferably a Java application that utilizes an IBM MQ series backbone to read messages and is multi-threaded, typically with a thread being dedicated to a single client or monitored system 14.

C. Solution Engine

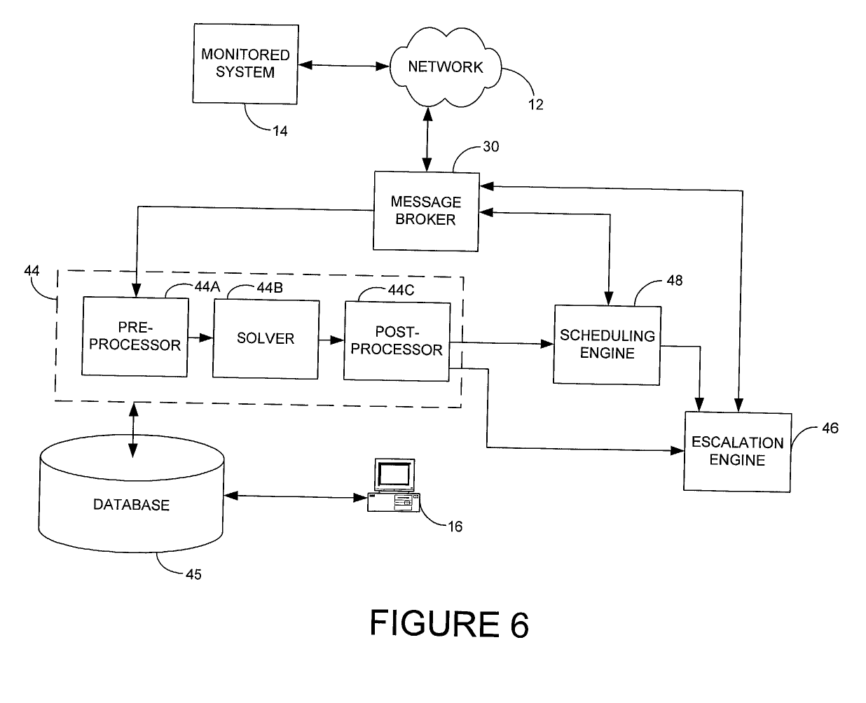

A more detailed diagram of the solution engine 44 is shown in FIG. 6. Data from a monitored system 14 is passed through the network 12 and is received at the message broker 30. The message broker 30 forwards the data to the solution engine 44. Depending upon the type of data received, the solution engine 44 performs different processing on the data.

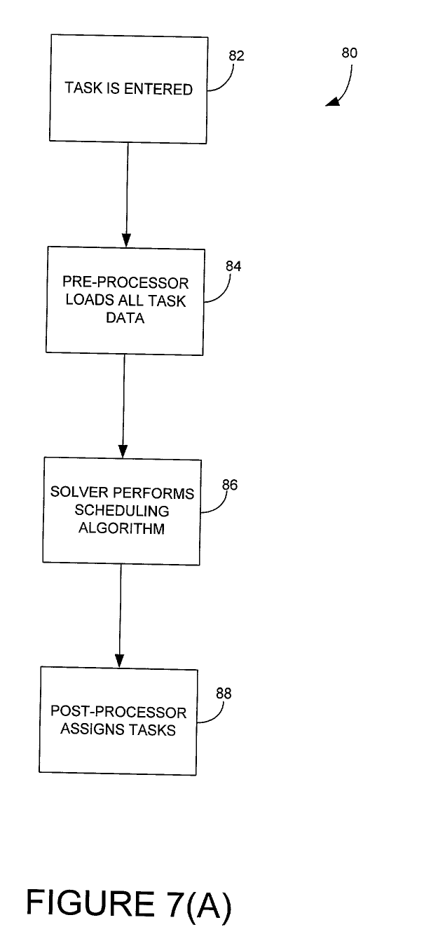

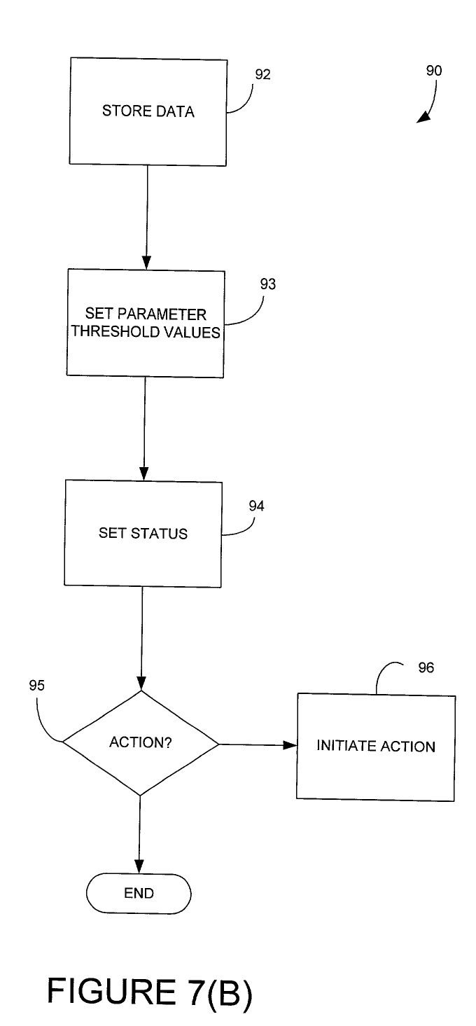

For example, if the data received is a task, the solution engine 44 performs a method 80 which will be described with reference to FIG. 7(A). At 82, the task is entered into the productivity center 10. The task may be entered in a number of ways including, but not limited to, a client requesting a task, a person at the productivity center 10 requesting a task, the monitored system 14 automatically requesting a task, or the solution engine itself requesting a task, such as in response to values of performance data received from the monitored system 14. Next, at 84, a pre-processor 44A within the solution engine 44 loads all task data from the database 45 with this task data including all task requests since a last run. Next, at 86, a solver 44B performs a scheduling algorithm to sort through the tasks and then at 88 a post-processor 44C assigns jobs in accordance with the scheduling algorithm. The scheduling algorithm used by the solver 44B will be described in more detail below but, in general, evaluates the available resources at the productivity center 10 and allocates the jobs in order to optimize use of such resources. The post-processor 44C assigns jobs to associates for all work that must be performed manually and assigns jobs to a scheduling engine 48 for those jobs that can be performed automatically, such as through scripts. Based on the results of the scheduling algorithm and assignment of jobs, the solution engine 44 may also send data or commands to an escalation engine 46 for such action as paging or e-mailing associates, the CIO associated with the monitored system 14, or other parties.

As another example, if the data received is not a job but was performance data, the productivity center 10 preferably performs a process 90 shown in FIG. 7(B). At 92, the solution engine 44 forwards the data for storage within the database 45. At 93, the solution engine 44 sets the parameter threshold values. The precise threshold value will, of course, vary with the parameter being measured at the monitored system 14 and possibly also upon the preferences of the client. Significantly, the productivity center 10 has a set of default threshold values reflecting best practices in the industry which are used in the event that no other threshold values are specified.

Based on these threshold values, the solution engine 44 sets the status of the parameter values at 94. In the preferred embodiment, the productivity center 10 employs parameter status values of green, yellow low, yellow high, red low, and red high for thresholds. For example, a measured parameter can have its status progressively changed through these different status colors and an administrator can visually determine the status for that parameter. The solution engine 44 also sets higher-level status values at 94. The higher-level status values, as will be described in more detail below, are shown in cockpits that reflect the status of individual parameters. A Basis status value reflects the most severe SAP parameter status, the Database status value reflects the most severe Oracle parameter status, and the Operating System status reflects the most severe CPU, memory, disk, file system, and network parameter status. The overall status therefore is based on the highest or most severe parameter status of that parameter grouping. Additionally, the solution engine 44 sets the overall system status, which reflects the most severe Basis, Database, and Operating System status value. While in the preferred embodiment the status of parameters, groupings of parameters, and overall status is represented visually through the five different colors, the invention is not limited to such a representation of status but encompasses other ways of conveying status information.

At 95, the solution engine 44 determines if any additional action needs to occur. Each of the above-mentioned yellow and red status values can be configured to perform actions if the parameter goes into a corresponding alert state based upon its currently measured value. For example the solution engine 44 can set a yellow low, yellow high, red low, and red high actions which are performed once the parameter goes into those corresponding states.

If the solution engine 44 determines that some action should occur, the solution engine 44 initiates the action at 96. The solution engine 44 can initiate an action in various ways. For example, the solution engine 44 can initiate a notification or alert through the escalation engine 46. Also, the solution engine 44 can initiate a job that needs to be performed by the scheduling engine 48 and/or through an associate. Some examples of actions include paging an individual or group, e-mailing an individual or group, such as through Internet mail, Palm Pilot, pagers, or other devices with e-mail addresses, output a message to cockpits, create a job based upon a task from the task dictionary, and execute a local or remote command.

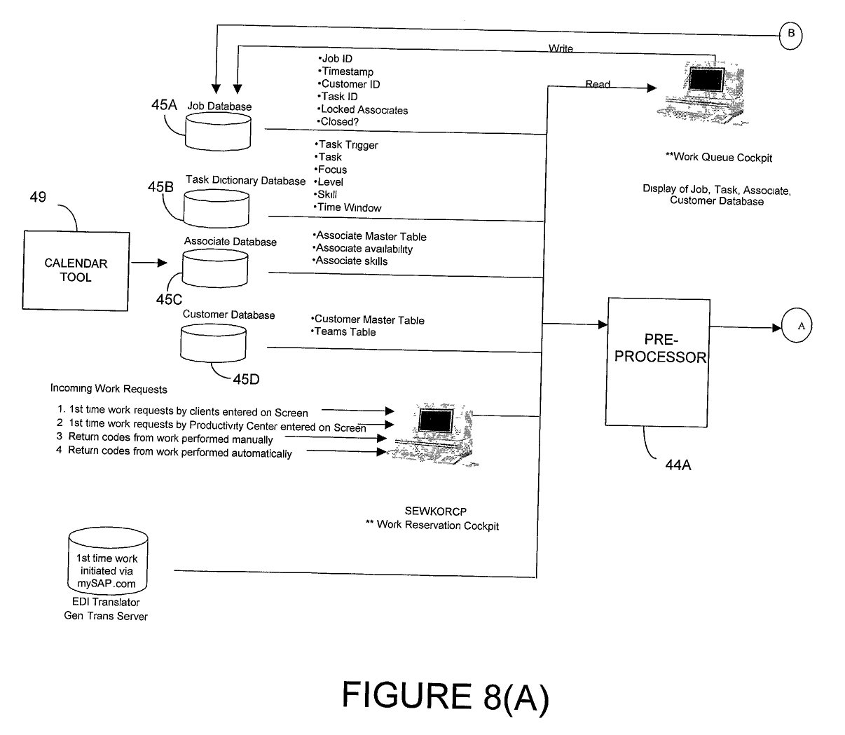

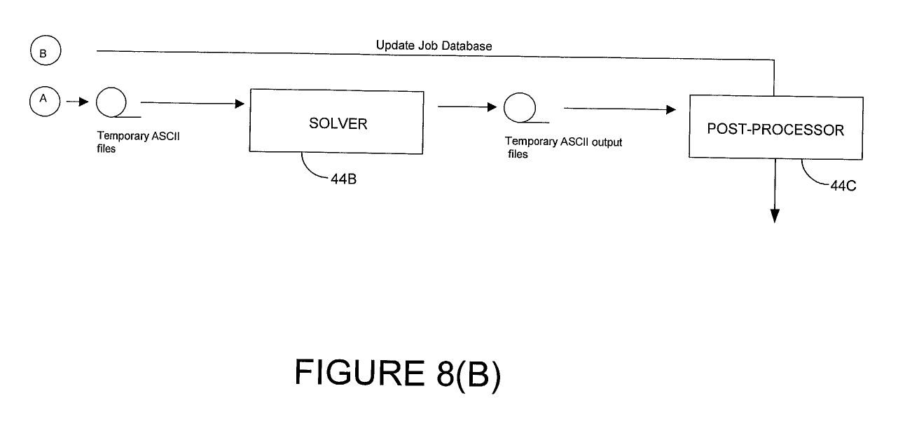

The scheduling of jobs will be described in more detail with reference to FIGS. 8(A) and 8(B). As shown in FIG. 8(A), the database 45 is comprised of a job database 45A, a task dictionary database 45B, and associate database 45C, and a customer database 45D. The job database includes general information on jobs, monitored systems 14, and clients. For instance, as shown in the figure, the job database may include a job ID, time stamp, customer ID, task ID, information on locked associates, and a closed indicator. The task dictionary database 45B defines the parameters and characteristics of tasks. For example, as shown in the figure, each task can be defined by a task trigger which causes a job to be worked on, a task descriptor, a focus, a priority level, a skill level required to perform the task, and a time window indicating the length of time needed to complete the job. The associate database 45C generally contains information on associate availability and skills. A calendar tool 49 maintains associate availability for ongoing operations and may interface with Microsoft Outlook Calendar in order to obtain such information. The associate database 45C includes such data as an associate master table, associate availability, and associate skills. The customer database includes data on a customer master table and teams table. The pre-processor 44A pulls data from each of these databases 45A to 45D and this data is used by the solver 44B in scheduling tasks to the associates.

The incoming work request may originate from a number of sources. For instance, the incoming work may be requested on screen by a client at the monitored system 14. The work may also originate within the productivity center 10 through an on screen request. Also, the work request may result from return codes from work performed manually, or from return codes from work performed automatically by the productivity center 10. The work may also be initiated by other external systems, such as through the Internet via mySAP.com. A work reservation cockpit 16 is a terminal that may be located within the productivity center 10, within the monitored system 14, or elsewhere which allows work requests to be entered. A work queue cockpit 16 can also be located within the productivity center 10, within the monitored system 14, or elsewhere users do see a display of jobs, tasks, associates, and customer database.

With reference to FIG. 8(B), from the pre-processor, the solver obtains the data necessary to assign associates to the tasks with this data including data from a task dictionary. The solver 44B preferably uses a mixed integer linear programming solver as part of its scheduling algorithm. The post-processor 44C takes the output from the solver 44B and makes appropriate updates to the job database 45A.

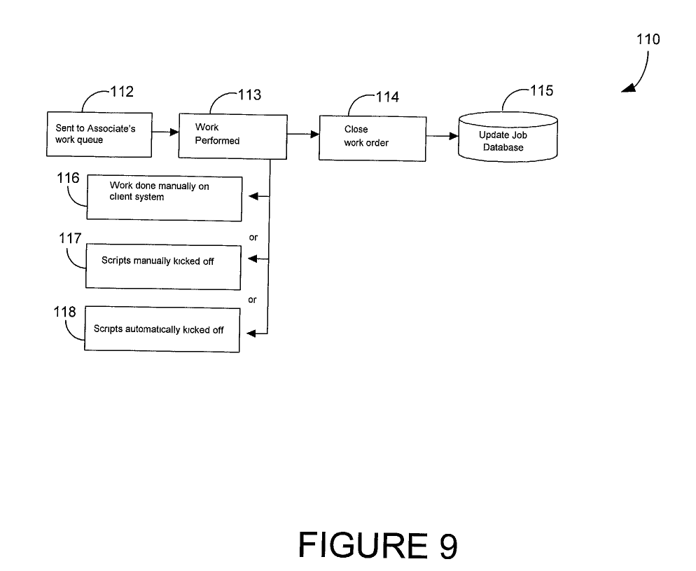

A method 110 of performing the work will now be described with reference to FIG. 9. At 112, the solution engine 44 sends work to an associates work queue. At 113, the work is performed followed by the associate closing the work order at 114. Once the work is done, the job database is updated at 115, such as through the associates work queue cockpit. As mentioned above, some of the jobs received by the solution engine 44 are to be performed manually by associates while other work can be performed automatically. Thus, at 113, the work may be performed manually on the monitored system at 116, the work may be performed automatically through scripts manually kicked off at 117, or the work may be performed automatically by scripts which were automatically kicked off through some triggering event. While not exhaustive, some examples of automatic scripts include a client copy script, client refresh script, transport script, copy database-rename database script, Check SAP_Arch file system (UNIX), check system response time (Oracle), check table space fragmentation (Oracle), check UNIX error logs (UNIX), monitor Oracle alert file (Oracle), monitor messaging server process (UNIX), check performance matrix and record for daily Oracle checks (Oracle), check performance matrix for daily UNIX checks (UNIX), and check performance matrix for daily SAP checks (SAP).

Table 1 shown below provides an example of entries in the customer database 45D. At a minimum, the customer database 45D includes a customer ID and preferably some corresponding description for the customer name.

TABLE 1

| Customer | |
|---|---|
| ID | Customer Name |
| CUST001 | Acme Company |
| CUST002 | Blake Industries |
| CUST003 | Clayton Manufacturing |
| CUST004 | Dellwood Management |

Table 2 shown below provides an example of some entries within the associate database 45C. In this example, five associates are shown of varying skill levels with skill level 3 being the highest skill level. As mentioned above, many of the tasks required to support SAP Basis require varying levels of skill level to complete. An associate with skill level 2 or 3 may work on a task needing skill level 1 but a skill level 1 associate will not be assigned to any tasks requiring level 2 or three skills. The entries in Table 2 also show the associates' availability. In this example, an hours available column reports the number of hours this shift that an associate is available for new work. The calendar tool 49 preferably tracks the hours available for each associate and monitors when each associate is out of the office, attending scheduled meetings, or tied up with an unfinished task from the previous shift. Associates are also preferably assigned to customer teams. The solver 44B attempts to assign primary team members to a job but will assign a secondary team member rather than miss a due date. The solver 44B will not assign an associate who is not on the customer's primary or secondary teams.

TABLE 2

| Associate | | Associate's | Hours | Teams: 1-Primary; 2-Secondary | | | |
|---|---|---|---|---|---|---|---|
| ID | Name | Skill Level | Available | CUST001 | CUST002 | CUST003 | CUST004 |
| SW001 | Smith, Alice | 3 | 8 | 1 | 1 | 2 | |
| SW002 | Johnson, Bob | 2 | 8 | 1 | 2 | 2 | 1 |
| SW003 | Jones, Clarice | 2 | 8 | | 1 | 2 | 1 |
| SW004 | Brown, Donald | 1 | 6 | 1 | | 1 | |
| SW005 | Davis, Elizabeth | 1 | 4 | 2 | 1 | | 1 |

Table 3 shows priority classification for tasks, which may be stored in the task dictionary database 45B. All tasks are pre-assigned a priority that can be overridden if necessary and the solver 44B uses a mid-value in the scheduling algorithm.

TABLE 3

| | | Priority Hours |
|---|---|---|
| Priority ID | Priority Description | (mid-value) |
| PRIORITY01 | 0-1 hours | 0.5 |
| PRIORITY02 | 1-4 hours | 2.5 |
| PRIORITY03 | 4-8 hours | 6 |
| PRIORITY04 | 8-24 hours | 16 |
| PRIORITY05 | More than 24 hours | 36 |

Table 4, shown below, defines predefined tasks, the skill level needed to complete the task, the priority of the task with accompanying priority hours to the due date, the expected hours from start to finish, and associate hours needed. The expected hours from start to finish is the total needed to complete the task. For example, a backup to cartridge tape may take five hours from the start to finish. In contrast, the associate hours needed is the time an associate is expected to be actively working on the task. For example, although a backup to cartridge may take five hours, an associate may only spend one hour initiating the backup, occasionally monitoring it, and then closing it out. The data contained within Table 4 may also be stored within the task dictionary database 45B.

TABLE 4

| | | | | Expected | |
|---|---|---|---|---|---|
| | | | Priority | Hours | |
| | Skill | | Hours | from | Associate |
| | Level | | (mid- | Start to | Hours |
| Task ID | Required | Priority ID | value) | Finish | Needed |
| TASK001 | 2 | PRIORITY01 | 0.5 | 0.5 | 0.5 |
| TASK002 | 2 | PRIORITY02 | 2.5 | 1.0 | 0.5 |
| TASK003 | 1 | PRIORITY02 | 2.5 | 2.5 | 1.0 |
| TASK004 | 3 | PRIORITY03 | 6.0 | 4.5 | 1.0 |
| TASK005 | 3 | PRIORITY03 | 6.0 | 6.0 | 3.0 |
| TASK006 | 1 | PRIORITY04 | 16.0 | 8.0 | 4.0 |

Table 5 provides an example of an open work queue. The pre-processor 44A retrieves the data contained within Table 5 from the database 45 and presents this to the solver 44B. With reference to Table 5, job ID is a sequential work order number and the arrival time stamp is the time in hours from the millennium that the job entered the work queue, such as from the productivity center 10 or manually. The customer ID refers to the customer ID shown in Table 1 found in the customer database 45D and the next six columns starting from the task ID through the associate hours needed correspond to the information contained within Table 4. A calculated time due is the arrival time stamp plus the priority hours. For example, JOB8052 entered the work queue at hour 10082. Since this job is a priority 3 job to be completed within six hours, the calculated time due is 10082+6=10088. A calculated latest start time is the calculated time due minus the expected hours from start to finish. For example, JOB8052 has a calculated time due of 10088. The expected hours from start to finish is 4.5 hours resulting in the calculated latest start time of 10088-4.5, which equals 10083.5.

The scheduling algorithm is designed to address a number of goals. As mentioned above, work is preferably assigned to primary team members associated with a client and, if that is not achievable, then to primary and secondary team members. The solver 44B therefore tries to maintain a common set of team members which are assigned to any client or monitored system 14. Also, if all future work cannot be accommodated during the present shift, then the solver 44B assigns the most critical work as a function of the due date to primary and secondary team members. The solver 44B assigns as much work as possible to associates with the lowest allowable skill in order to preserve flexibility of the higher skilled associates. The solver 44B also assigns work so that everyone is working on something and to balance the workload so that some associates do not have a disproportionate share of the workload.

TABLE 5

| | | | | | | | Expected | | | |
|---|---|---|---|---|---|---|---|---|---|---|
| | Arrival, | | | Skill | | | Hours | Associate | | Calculated |
| | Time | Customer | | Level | | Priority Hours | from Start | Hours | Calculated | Latest |
| Job ID | Stamp | ID | Task ID | Required | Priority ID | (mid-value) | to Finish | Needed | Time Due | Start Time |
| JOB8051 | 10081 | CUST001 | TASK005 | 3 | PRIORITY03 | 6.0 | 6.0 | 3.0 | 10087.0 | 10081.0 |
| JOB8052 | 10082 | CUST002 | TASK004 | 3 | PRIORITY03 | 6.0 | 4.5 | 1.0 | 10088.0 | 10083.5 |
| JOB8053 | 10082 | CUST004 | TASK001 | 2 | PRIORITY01 | 0.5 | 0.5 | 0.5 | 10082.5 | 10082.0 |
| JOB8054 | 10083 | CUST003 | TASK006 | 1 | PRIORITY04 | 16.0 | 8.0 | 4.0 | 10099.0 | 10091.0 |
| JOB8055 | 10085 | CUST001 | TASK003 | 1 | PRIORITY02 | 2.5 | 2.5 | 1.0 | 10087.5 | 10085.0 |
| JOB8056 | 10085 | CUST004 | TASK006 | 1 | PRIORITY04 | 16.0 | 8.0 | 4.0 | 10101.0 | 10093.0 |
| JOB8057 | 10086 | CUST003 | TASK002 | 2 | PRIORITY02 | 2.5 | 1.0 | 0.5 | 10088.5 | 10087.5 |

An exemplary mathematical algorithm for satisfying the goals of the solver 44B is shown below. The mathematical model is a binary integer knapsack type problem and its expression in AMPL format is as follows:

| | |
|---|---|
| set ASSOC; | # associates |

| | |
|---|---|
| set JOB; | # jobs |

| | |
|---|---|
| param avail {ASSOC} >=0; | # max hours available, each associate |

| | |
|---|---|
| param time {JOB} >=0; | # associate time needed, each job |

param coef {ASSOC, JOB} <=0; # proprietary objective function coefficient
var AtoJ {ASSOC, JOB} binary; # assign associate A to job J

| | |
|---|---|
| minimize penalty: | # coefficients can be thought of as penalties for |

# not assigning an associate to a job

sum {a in ASSOC, j in JOB}

coef[a,j] * AtoJ[a,j];

# cannot assign more work than associate can handle

subject to Time_Avail {a in ASSOC}:

sum {j in JOB} time[j] * AtoJ[a, j] <= avail [a];

# only one associate per job

subject to One_Associate {j in JOB}:

sum {a in ASSOC} AtoJ[a,j] <= 1;

# everyone works on something

subject to All_Skate {a in ASSOC}:
sum {j in JOB} AtoJ[a,j] >= 1;

The output of the solver 44B is represented below in Table 6. The last three columns of Table 6 list the associate assigned to each job, their respective skill level, and an indication as to whether or not they are a primary or secondary team member. In reviewing this table, it should be apparent that all jobs are assigned to associates with matching skill levels and that all but one assignment is made to a primary team member.

TABLE 6

| | | | | | | | Ex- | | | | | | |
|---|---|---|---|---|---|---|---|---|---|---|---|---|---|
| | | | | | | | pected | | | | | As- | |
| | | | | Skill | | Priority | Hours | As- | Calcu- | | | soci- | Primary |
| | Arrival | | | Level | | Hours | from | sociate | lated | Calculated | | ates | or Sec- |
| | Time | Customer | | Re- | | (mid- | Start to | Hours | Time | Latest Start | As- | Skill | ondary |
| Job ID | Stamp | ID | Task ID | quired | Priority ID | value) | Finish | Needed | Due | Time | sociate | Level | Team? |
| JOB8051 | 10081 | CUST001 | TASK005 | 3 | PRIORITY03 | 6.0 | 6.0 | 3.0 | 10087.0 | 10081.0 | SW001 | 3 | P |
| JOB8052 | 10082 | CUST002 | TASK004 | 3 | PRIORITY03 | 6.0 | 4.5 | 1.0 | 10088.0 | 10083.5 | SW001 | 3 | P |
| JOB8053 | 10082 | CUST004 | TASK001 | 2 | PRIORITY01 | 0.5 | 0.5 | 0.5 | 10082.5 | 10082.0 | SW003 | 2 | P |
| JOB8054 | 10083 | CUST003 | TASK001 | 2 | PRIORITY01 | 0.5 | 0.5 | 0.5 | 10083.5 | 10083.0 | SW002 | 2 | S |
| JOB8055 | 10085 | CUST001 | TASK003 | 1 | PRIORITY02 | 2.5 | 2.5 | 1.0 | 10087.5 | 10085.0 | SW004 | 1 | P |
| JOB8058 | 10085 | CUST004 | TASK006 | 1 | PRIORITY04 | 16.0 | 8.0 | 4.0 | 10101.0 | 10093.0 | SW005 | 1 | P |
| JOB8057 | 10086 | CUST003 | TASK002 | 2 | PRIORITY02 | 2.5 | 1.0 | 0.5 | 10088.5 | 10087.5 | SW002 | 2 | P |

D. Scheduling Engine

The scheduling engine 48 executes the running of remote tasks on the monitored systems 14. The scheduling engine 48 receives the jobs from the solution engine 44. The scheduling engine 46 has job dependencies so that certain jobs are worked on based on work performed on other jobs. For example, a single job may require multiple tasks which must be performed in a prescribed order. The scheduling engine 48 therefore ensures that the jobs are worked on in the proper order. The scheduling engine 48 also has job retry capability. Thus, if the scheduling engine 48 does not receive confirmation that a job was successfully completed, the scheduling engine 48 will retry that job until the work has been successfully completed. The scheduling engine 48 also has alerting capability through the escalation engine 49.

The scheduling engine 48 receives job timing and dependency information from the post-processor 44C. This data is preferably received from the post-processor 44C on a periodic basis. At the scheduled time, the scheduling engine 48 runs an appropriate script for the task, which sends a control packet through the message broker 30 and on to the monitored system 14 and its associated watchdog agent. Once the job is completed at the monitored system 14, the remote watchdog agent sends an error status back through the network 12 to the message broker 30, which then writes the completion status to the job log within the database 45. The scheduling engine 48 then reads the completion status to ensure that the job or task was successfully completed. If there are other job dependencies in the job stream, the scheduling engine 48 then starts completing the jobs based on the completion status.

E. Escalation Engine

The escalation engine 46 performs any notification or escalation required based on the tasks or data received from the monitored systems 14. The escalation engine 46 supports two-way paging, logs incoming responses, and provides for remote command capability. The scheduling engine 48, the solution engine 44, and the message broker 30 all have interfaces with the escalation engine 46 and can initiate an escalation. The escalation engine 46 preferably uses notification software Telalert from Telemon Corporation and provides graphical user interface (GUI), command line, and application program interface (API) interfaces.

F. Associate Cockpit

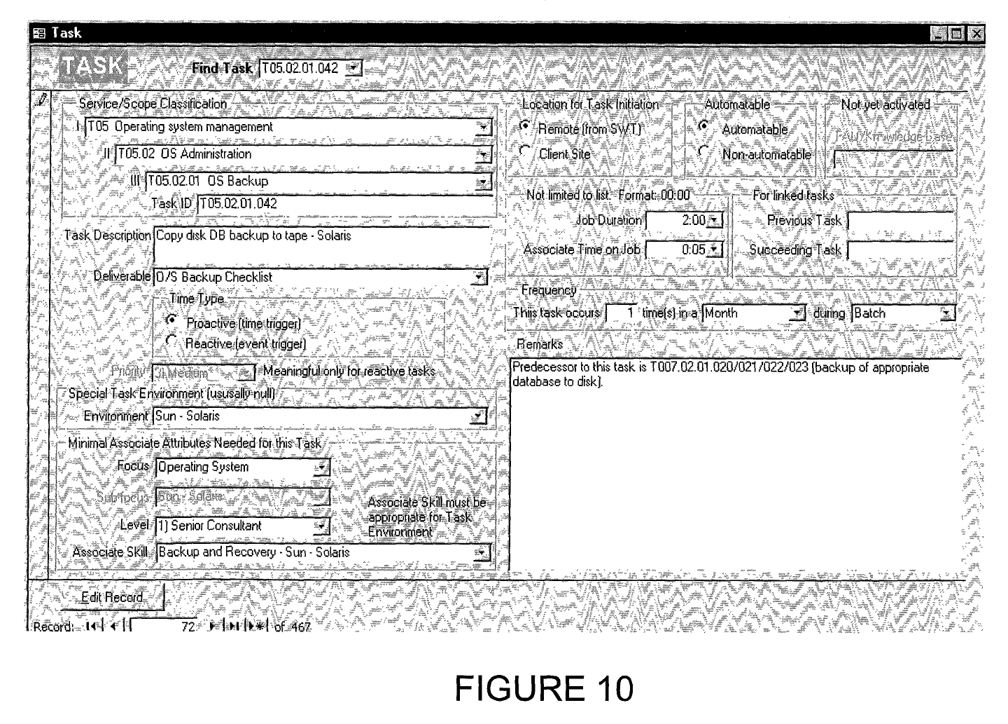

FIG. 10 illustrates an interface concerning a specific task that may be performed by the productivity center 10. As shown in this interface, the task has service/scope classification materials which indicate that the task is an operating system backup and has a task ID of T05.02.01.042. The task description is copy disk database backup to tape for Solaris and is a proactive type of task. The task is performed in a Sun-Solaris environment and also specifies the minimal associate attributes needed for the task. As shown in FIG. 10, the task is initiated remotely from the productivity center 10, is automatable, and lists the job duration as two hours and associate time on job as five minutes. This task should occur once a month in batch mode and also specifies a predecessor task of a backup of appropriate database to disk. Thus, when the productivity center 10 initiates a job for performing this task, the productivity center 10 ensures that the predecessor task has been performed.

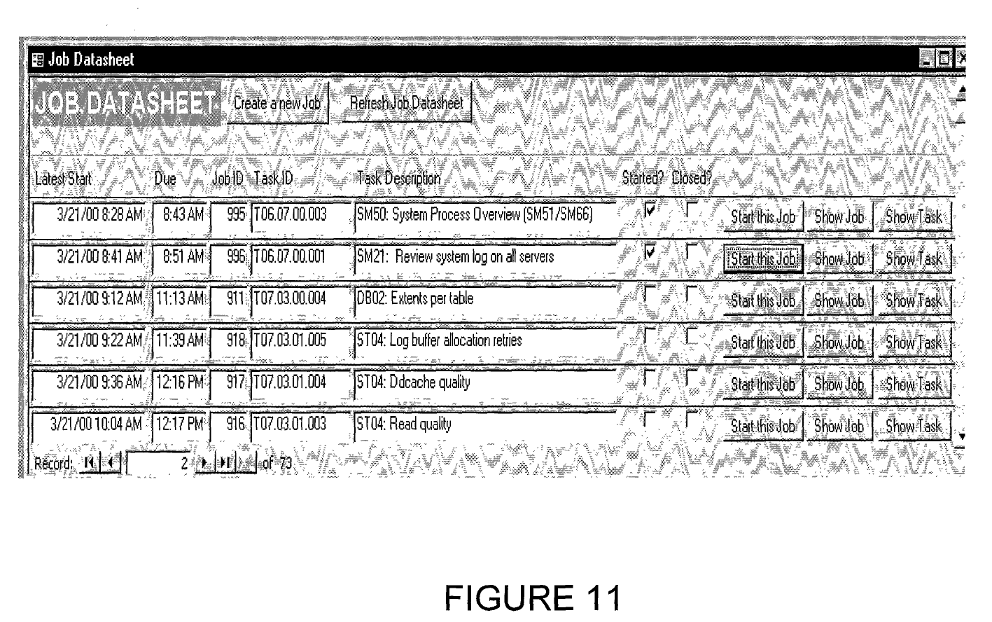

A job is a time and customer instance of a task. Each associate has a list of open tasks with those that must be accomplished placed toward the top of the list. An example of a job data sheet for an associate is shown in FIG. 11. The job database is frequently updated to purge finished and reassigned jobs and to display new jobs assigned to the associate. With reference to the figure, through this interface an associate can view the list of jobs that must be performed along with the associated latest start time, the due time, and a task description. An associate can select the “Start this Job” button to begin work on a particular job, can select a “Show Job” button to show additional details about the job, or can select the “Show Task” button to view details of the task. Through this interface, the associate can also check jobs as being started and also check when the associate has closed and finished the job.

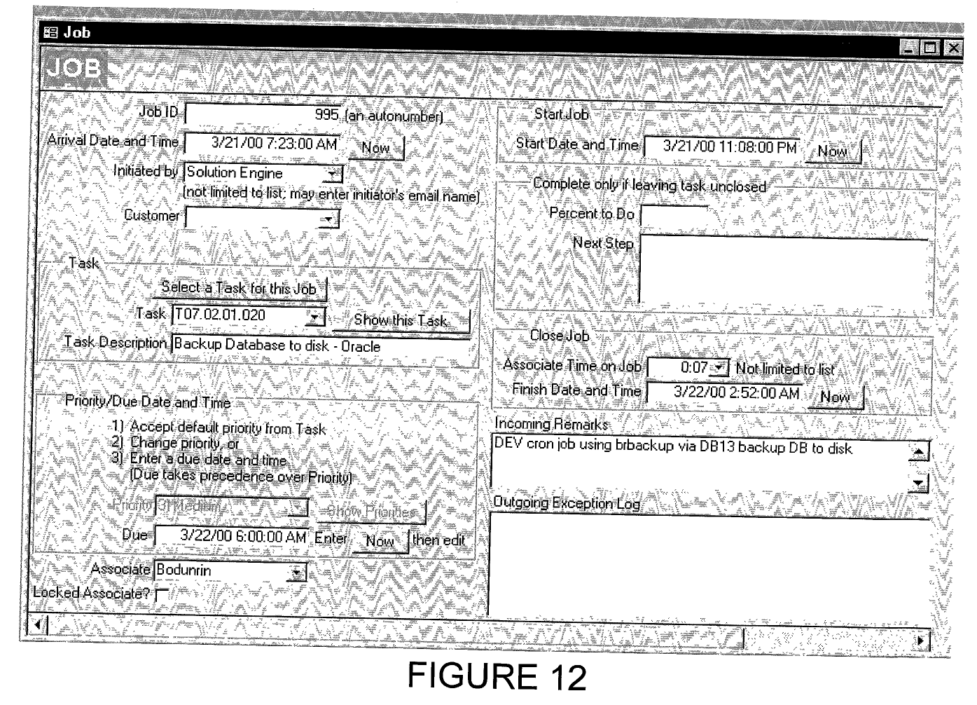

An example of an interface provided to an associate upon selection of the “Show Job” button is shown in FIG. 12. Through this interface, the associate can close a job or specify any additional work that needs to be performed before the job can be closed.

G. Examples

As mentioned above, the invention can be applied to various types of servers as well as other types of elements and devices. With regard to servers, examples will be given below on providing remote support to an application, specifically SAP Basis, to a database, and also to an operating system.

(1) Application/Basis

To illustrate some advantages of the invention, a description will be given below which contrasts a job which is performed both with and without the benefit of the productivity center 10. Without the productivity center 10, as is conventional, a client copy job is performed by a Basis administrator who first locks the SAP system from users logging into it. The Basis administrator then next logs onto the system and copies the SAP user master tables to a holding client. The SAP Basis administrator then manually configures SAP to perform the copy, monitors the progress of the copy, and resolves any errors. Once the client copy has been completed, the Basis administrator then unlocks the system to allow users to log in. The total time to perform such a process is typically around five to six man hours and is performed three times per week during build and about once every two weeks during production.

In contrast to the conventional process, a client copy with the productivity center 10 can be scheduled through the solution engine 44 via a work reservation cockpit. Through this cockpit, the Basis administrator can specify the date and time a client copy needs to be performed. From the work queue, a task monitor is assigned to someone who is responsible for the task should an error occur. Before the task is executed, the solution engine 44 passes the task parameters to the task monitor via an e-mail notification using the escalation engine 46. The task monitor verifies the task by replying to the e-mail and making any adjustments, such as to the time of execution. The solution engine 44 builds the scripts to execute the client copy based on the parameters and this script copies the monitored system 14 at the designated time automatically. If an error occurs, the solution engine 44 through the escalation engine 46 notifies the task monitor via a page. Otherwise, the solution engine 44 through the escalation engine 46 notifies the task monitor of a successful client copy via e-mail and the client technical cockpit 16 reflects that the refreshed activity has taken place.

With the productivity center 10, approximately 90% of the manual tasks can now be automated. Whereas the Basis administrator would need to spend approximately five to six man hours completing a client copy, with the productivity center 10 the Basis administrator needs to intervene in only an error situation and is automatically notified when the task is complete. Because the productivity center 10 substantially reduces the amount of time needed by a Basis administrator, the productivity center 10 offers significant reductions in cost to the monitored system 14.

(2) Database

An example will now be given of a database task performed through the productivity center 10. In this example, the task is a reorganized table space task performed in Oracle. Typically, the database reorganization is done either by a database administrator or a Basis administrator. The process of reorganizing the database is typically performed by first stopping SAP via the command line. Next, Oracle is stopped via SAPDBA or through an Oracle administrator tool SQLDBA. The administrator then starts the reorganization via a third party tool, SQLDBA or SAPDBA. The database administrator must then monitor the reorganization and to ensure that it is successfully completed. Once the reorganization has been completed, the administrator then starts Oracle and SAP. The total time is approximately 10 to 40 man hours and is performed about twice per month.

On the other hand, with the productivity center 10, the Basis administrator schedules the database reorganization through the solution engine 44 via the work reservation cockpit 16. The Basis administrator specifies the date and time when the monitored system 14 will be available for the Oracle reorganization. In addition to, or instead of a manual request for the work, when the productivity center 10 determines that the table or table space is at a certain fragmentation level, the solution engine 44 may automatically schedule the reorganization.

As with the client copy, the productivity center 10 schedules a task monitor through the work queue. Before executing the task, the solution engine 44 sends task parameters to the task monitor for verification, which then verifies the task by replying to the e-mail. The solution engine 44 builds the script to execute the database reorganization based on the database tool used at the monitored site 14. The scheduling engine 48 then executes the script to automatically perform the reorganization at the designated time. If an error occurs, the scheduling engine 48 uses the escalation engine 46 to notify the task monitor via a page. If the job is performed successfully, the scheduling engine 48 sends the task monitor an e-mail through the escalation engine 46 that the job was completed. The client technical cockpit will reflect the work as being performed.

Whereas the conventional reorganization of a table space takes about 10 to 40 man hours, the productivity center 10 reduces that time to about 10 to 20 machine hours. Approximately 90% of the manual tasks are now automated for an Oracle reorganization of a table space. Further, the monitoring of the database reorganization is now automated, requiring intervention only in an error situation. The productivity center 10 also automatically notifies the client when the task is complete. The risk to the monitored system 14 is reduced since the task is performed when desired by the client. As with the client copy, the reorganization of a table space is not as time consuming, thereby reducing the cost.

(3) Operating System

An example will now be given of monitoring the UNIX system level activity. Normally, monitoring UNIX system level activity is done by the Basis administrator or the UNIX administrator. The administrator uses check lists to perform the monitoring, which typically requires about two hours a day to execute. In performing the monitoring, the administrator logs onto the UNIX machine and reviews the system logs, checks performance, and reacts to any critical system messages. For example, the administrator may determine that a server has a full file system in which case the UNIX administrator manually grows the file system.

In contrast, with the productivity center 10 the solution engine 44 performs system checks on an hourly basis, thus removing the need to monitor the system manually. When the solution engine 44 determines that a file system is full, the solution engine 44 schedules a “grow file system task” to be executed by a UNIX administrator. The solution engine 44 prioritizes the task for the administrator through the work queue. A technician then logs onto the appropriate system and grows the UNIX file system. The administrator then closes out of the task, which is reflected in the client technical cockpit. The total time with the productivity center 10 for monitoring the UNIX system level activity in responding is about 10 machine minutes.

The productivity center 10 provides substantial benefits in that all monitoring of the UNIX environment is automated, thus reducing costs for the client. Further, tasks are scheduled automatically when needed and the client is automatically notified when the task is scheduled and also when complete.

H. Wireless Architecture

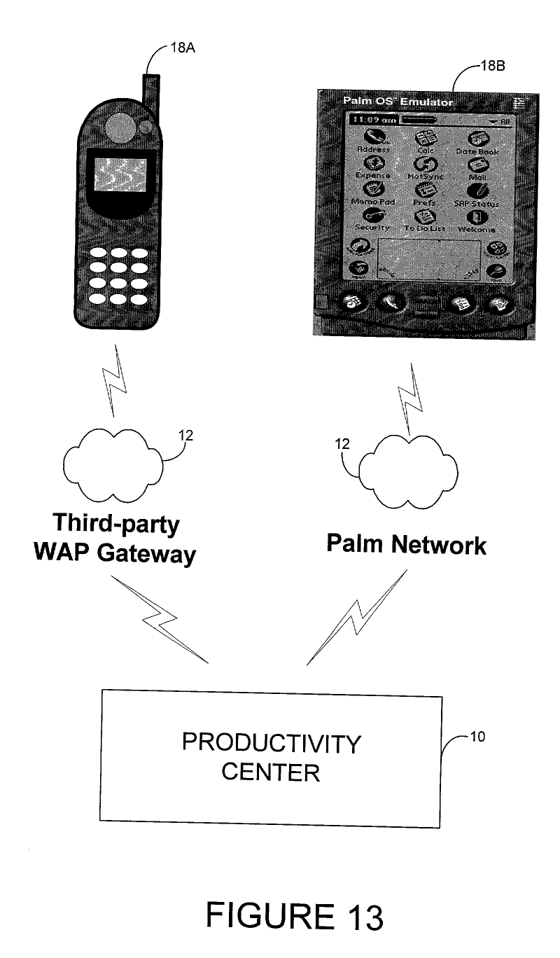

As represented in FIG. 1, wireless devices 18 are able to communicate through the network 12 with either the productivity center 10 and/or the monitored systems 14. FIG. 13 provides a more detailed diagram of the architecture supporting wireless communications. In this example, the wireless devices 18 are represented as a mobile radiotelephone 18A and also a personal digital assistant (PDA), namely a Palm Pilot 18B. An end user of the wireless device 18 initiates a session using an icon on the Palm Pilot 18B or a URL bookmark on the device 18. The network 12 includes a third-party network that provides the RF connectivity and Internet gateway to connect with the productivity center 10. Based on 15 the request received from the wireless devices 18, the productivity center 10 retrieves the desired data and forwards it to the wireless device 18. The productivity center 10 uses Internet Information Server (IIS) web service from Microsoft which support MIME types utilized by the wireless markup language (WML) and the Palm query language. The productivity center 10 supports the wireless application protocol (WAP) as well as future developed protocols. In addition to responding to queries from the wireless devices 18, the productivity center 10 may also automatically initiate communications with the wireless devices 18. For example, as discussed above, the escalation engine 46 sends out notifications and alerts via e-mail, pages, text messages, etc. which may be delivered to the wireless devices 18.

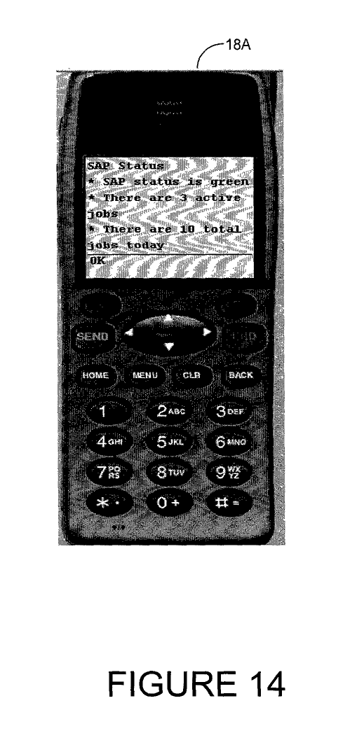

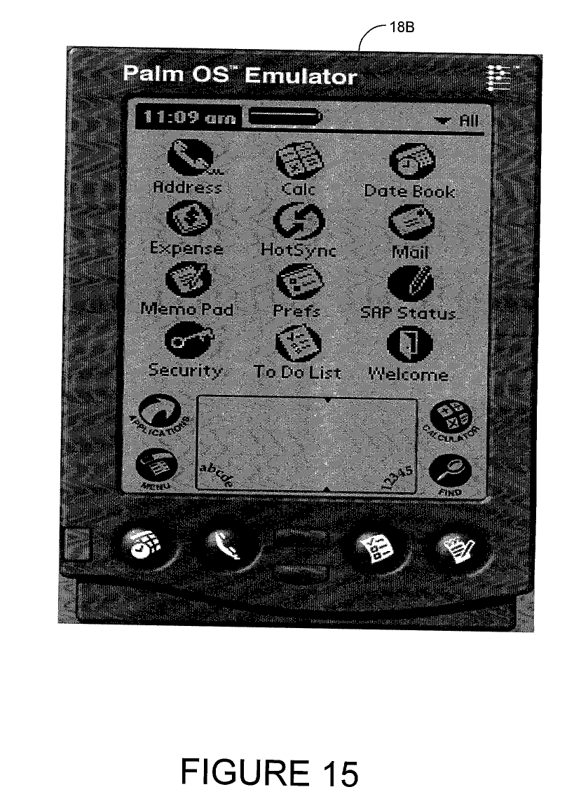

FIG. 14 provides an example of a mobile radiotelephone displaying status information received from the productivity center 10. FIG. 15 illustrates the Palm Pilot 18B having an SAP status icon for allowing the user to download status information from the productivity center 10. The productivity center 10 preferably delivers status information upon demand, e-mail and/or page clients important SAP, operating system, database, network, and other information on an event-driven basis, and allows for subsequent two-way interactivity by allowing the client to respond to that information by phoning, paging, or e-mailing a response back. For example, the productivity center 10 can notify a client through one of the wireless devices 18 of an important event occurring on their SAP landscape. The client then selects an e-mail address to compose an e-mail message or selects a phone number of a help desk associated with the productivity center 10. The client sends a message back to the productivity center 10, such as through the e-mail, text message, Internet, or help desk, with this response possibly triggering another communication from the productivity center 10.

III. Client Side

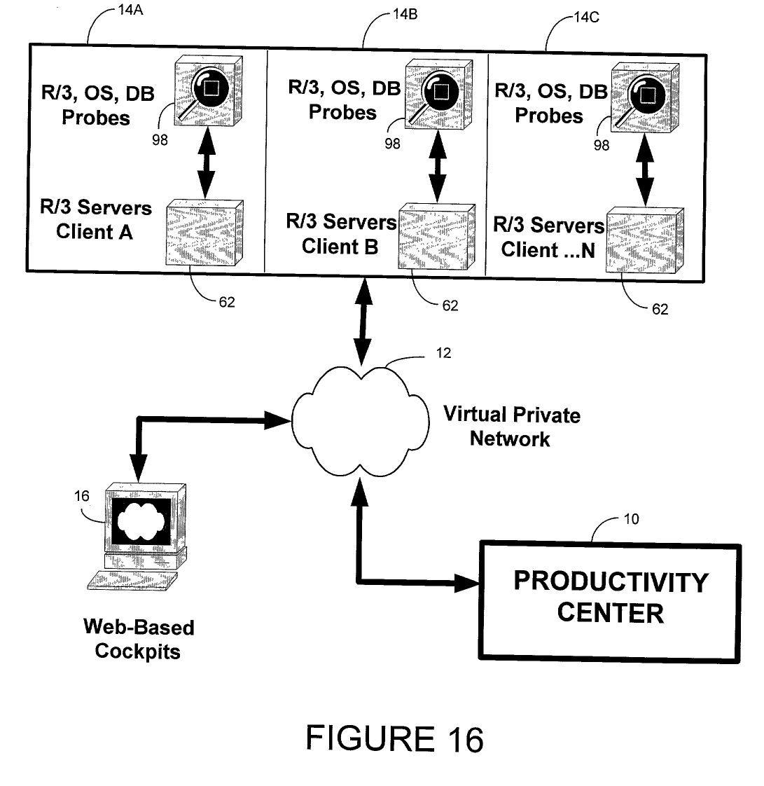

FIG. 16 illustrates a more detailed diagram of the monitored systems 14. In this example, the productivity center 10 provides remote support for three monitored systems 14A, 14B, and 14C. Each of these monitored systems 14 has one or more servers 62 with associated probes 68. As represented in the figure, these probes 68 may be for SAP R/3 servers, for the operating system, or for the database. The probes 68 gather data and send the data through the virtual private network 12 to the productivity center 10.

A. Probes

In the preferred embodiment, the probes measure approximately 200 parameters on each server. The probes 68 include a probe 68 for the central processing unit (CPU) and disk data, a probe 68 for SAP, a probe 68 for file system, a probe 68 for the network, a probe 68 for logs, a probe 68 for Oracle or other database server, and a probe 68 for memory. The monitored systems 14 may include additional or viewer number of probes 68 for measuring these or other parameters. Preferably, each probe 68 can be disabled through an initialization file setting and additional probes can be added through custom shell scripting and/or Java programming.

The probes 68 gather data at predefined times. An initialization file setting for each probe 68 defines the interval at which data is collected, with a default time of 15 minutes. In addition to measuring data at predefined intervals, the probes 68 also gather alerts, messages, and other events and forward this data to the productivity center 10.

B. Client Cockpits

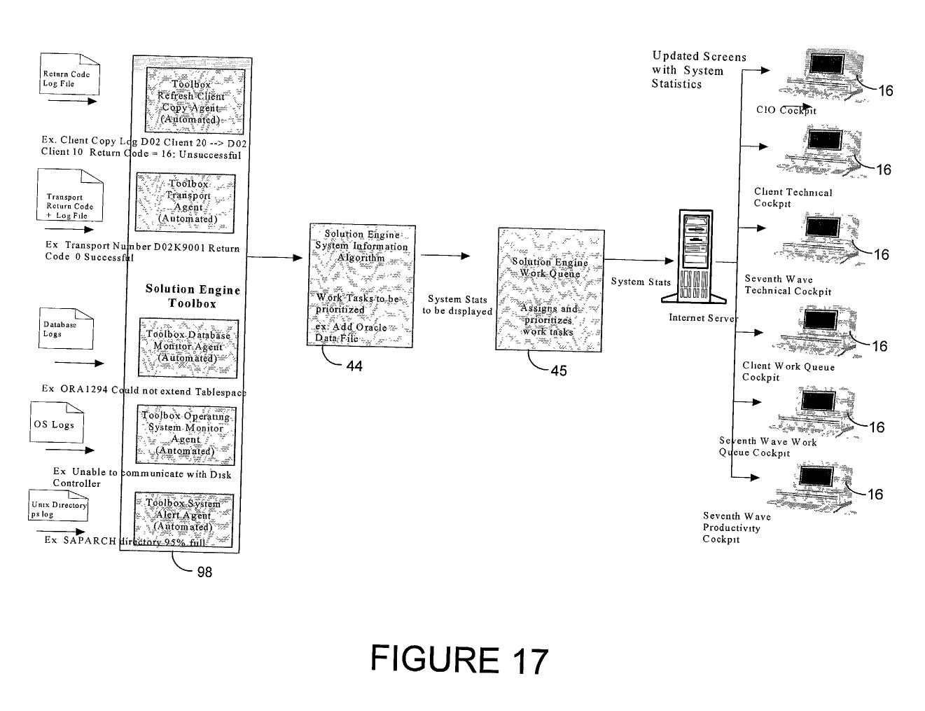

FIG. 17 provides an example of data being sent from monitored systems 14 to the productivity center 10. As shown in this diagram, the probes 98 include a toolbox refresh copy agent which gathers data from a return code log file, a tool box transport agent that gathers transport return codes and log file, a tool box database monitor agent for retrieving data from database logs, a tool box operating system monitor agent for retrieving data from operating system logs, and a tool box system alert agent for retrieving data from UNIX directory ps log. The data from the probes 98 is routed to the productivity center 10 and goes to the solution engine 44. As explained above, the solution engine 44 performs various functions on the incoming data including prioritizing work jobs and updating the work queue for associates. The status on the monitored systems 14, the values of the measured parameters, the status of the parameters, as well as alerts and notifications can be delivered to the terminals 16. The terminals or cockpits 16 include one for a CIO, a client technical cockpit, a cockpit at the productivity center, a work queue cockpit for the client, a work queue cockpit for the productivity center 10, and a productivity center cockpit. The client technical cockpits 16 include a database cockpit, and a basis cockpit. The data and interfaces available through these cockpits 16 will be described in greater detail below.

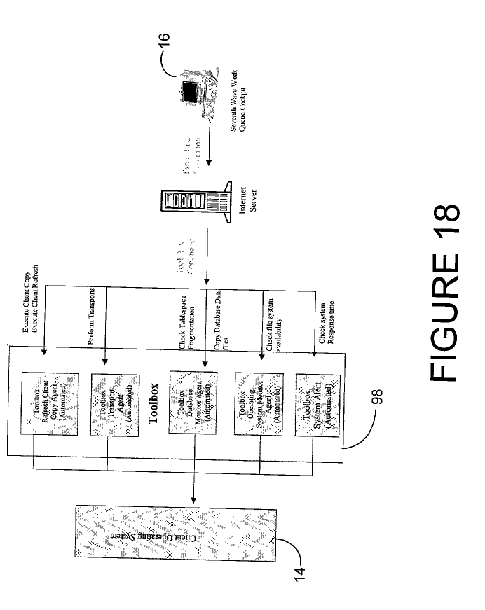

FIG. 18 illustrates an exemplary data flow from the productivity center 10 to one of the monitored systems 14. In this example, an associate may perform some work or some scripts may automatically be run which generate front-end commands. These commands are forwarded to the probes 98 at the monitored system 14. The commands from the productivity center 10 may go to a tool box refresh copy agent for executing a client copy or a client refresh, may go to a tool box transport agent for performing transports, may to a tool box data base monitor agent for checking table space fragmentation or copying database data files, may go to a tool box operating system monitor agent for checking file system availability, or may go to a tool box system alert for checking system response time. The various probes and agents 98 at the monitored system then interact with the monitored system 14 in executing their commands, such as with the client operating system.

The agents and probes 98 shown in FIGS. 17 and 18 are provided for illustration purposes only and the invention may include additional or other probes and agents.

C. User Interfaces

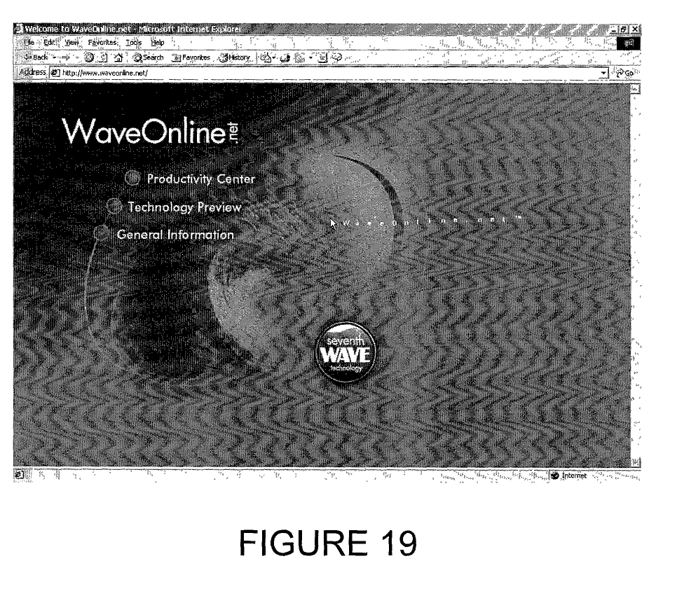

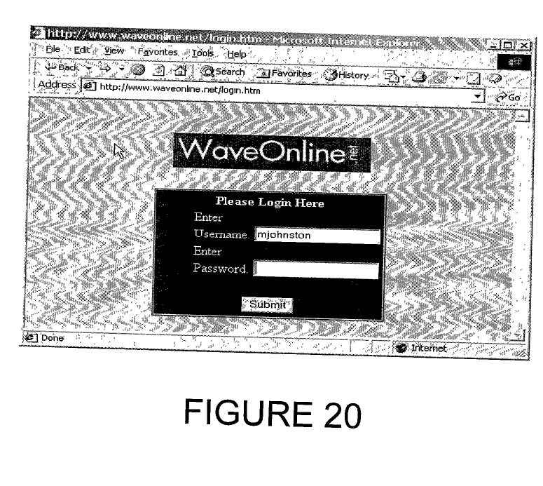

An explanation will now be given on exemplary interfaces provided to users through the terminal 16. With reference to FIG. 19, the productivity center 10 is accessible through the Internet, such as at www.waveoneline.net. FIG. 19 illustrates the view from a user's browser through any of the terminals 16. Selecting the “Productivity Center” link, the user is then presented with the interface shown in FIG. 20, which is a login screen. The user enters their user ID and password and then selects the “submit” button. The productivity center 10 limits access based on the user.

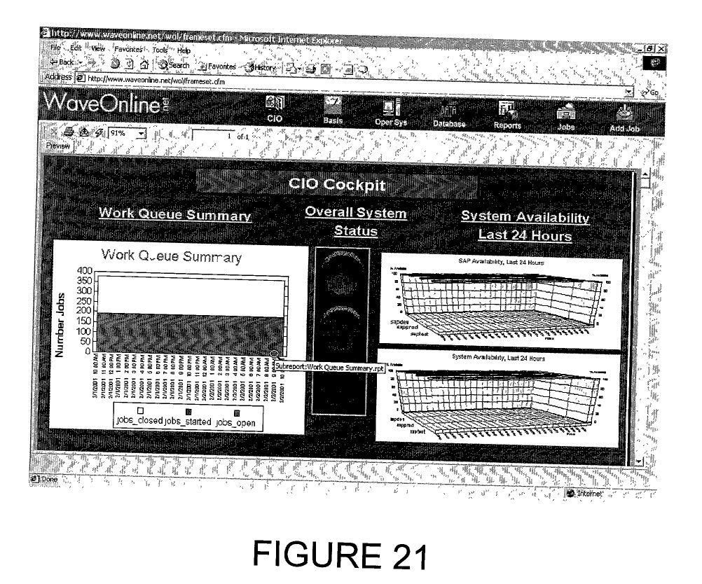

FIG. 21 provides an example of an interface to the productivity center 10 for a CIO. This CIO cockpit is an overall view of the SAP system's health. A work queue summary shows the status of open, started, and completed jobs in the job queue, and the overall system status gives an overall view of the systems status. As described above, the overall system status is based upon the highest or most severe status for the SAP status, operating status, and database status. In this example, the overall system status is represented by a stop light with the respective color for the current status being on the interface. This, if one parameter on one server goes to a status “red” then the overall system status will show an overall “red” as the status. On the other hand, if everything is fine across the board, the overall system status will have a “green” light displayed. The CIO cockpit also shows system availability over the last 24 hours. In this example, the system availability is shown with a set of graphs, which the CIO can click to display a larger version. The graphs shown in FIG. 21 include SAP availability for the last 24 hours and system availability for the last 24 hours.

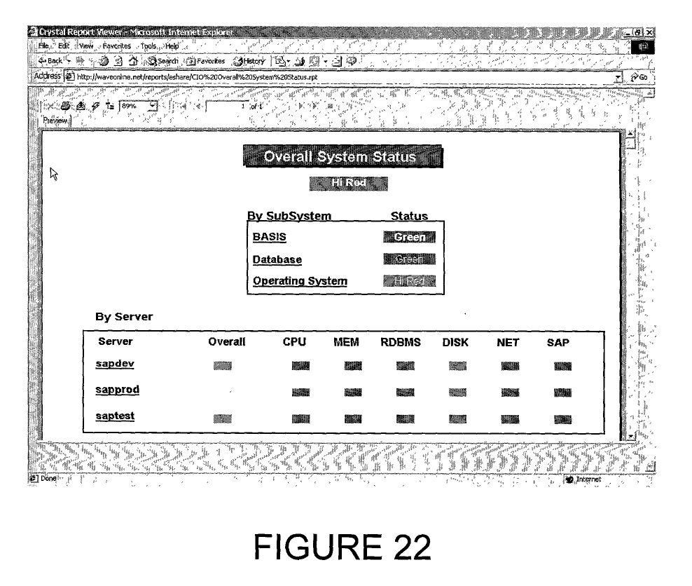

By clicking the “over all system status” link, the CIO is presented with the over all system status interface shown in FIG. 22. The over all system status interface illustrates the status level for the over all system as well as the status level for each subsystem, such as for Basis, database, and operating system. Preferably, the interface also breaks down the status per server and, furthermore, for each parameter measured on the corresponding server. By clicking on any of the colored blocks, the productivity center 10 will display a specific cockpit which allows the CIO to investigate issues further.

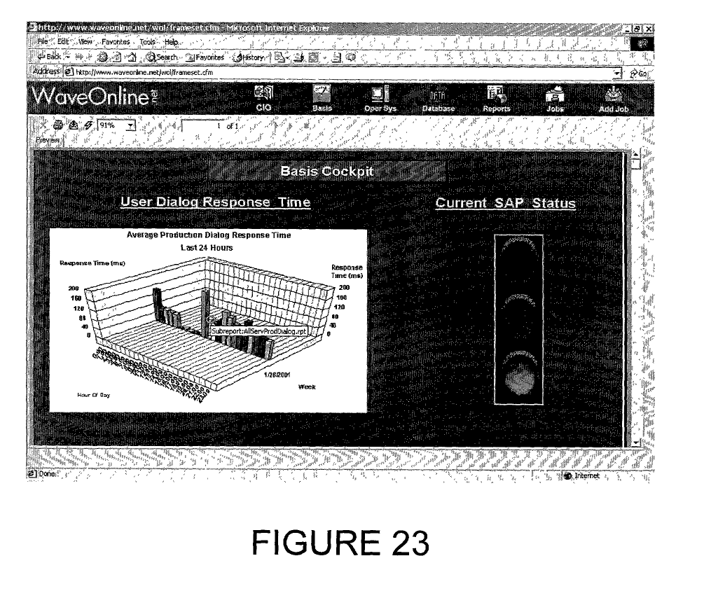

As shown in FIG. 21, the productivity center 10 provides a number of cockpits for a user, including CIO, Basis, operating system, database, reports, jobs, and add job. An example of a Basis cockpit is shown in FIG. 23. The Basis cockpit includes a user dialog response time for the last 24 hours. This response time is what most SAP end-users are seeing while moving through transactions. The Basis cockpit also shows the current SAP status, such as through a “stop light.” The Basis cockpit shows the status of parameters from within SAP itself and all parameters are found within SAP and most likely are accessed or repaired within SAP.

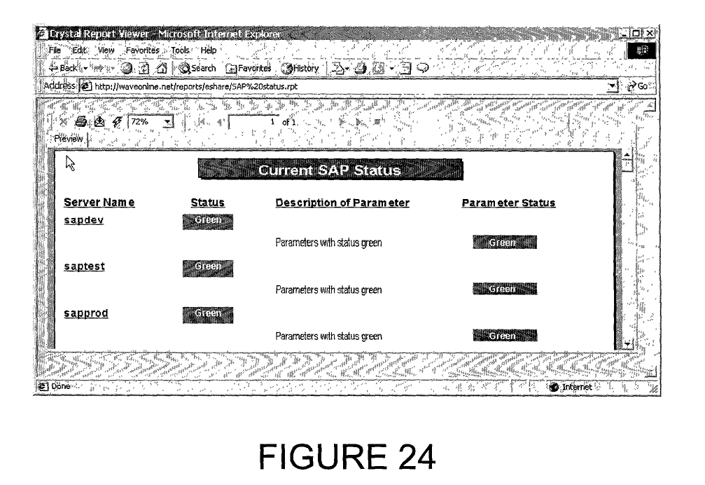

By selecting the “current SAP status” link, the user is provided with an interface such as the one shown in FIG. 24. This interface shows the status of individual parameters within the Basis cockpit and, in this example, shows all parameters as green. When clicking on a green block, the productivity center 10 provides a list of all of the green parameters. If there is a parameter outside of the predefined threshold with a status of yellow or red, the particular parameters are shown with a hot link in either “yellow” or “red.”

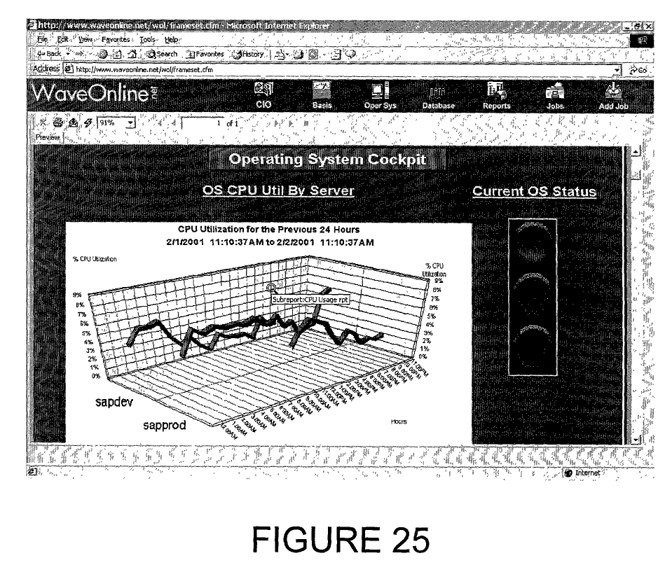

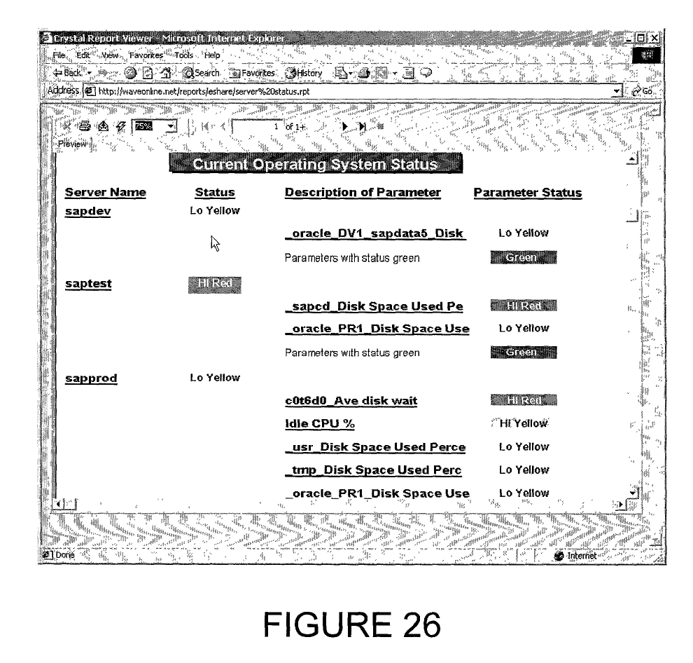

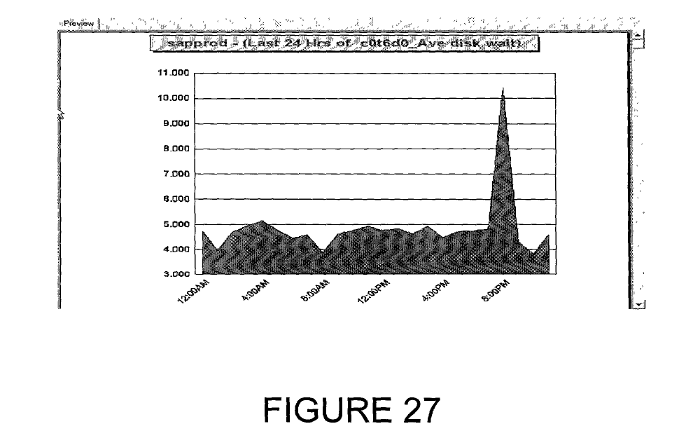

When a user selects the Operating System cockpit, the user receives an interface such as the one shown in FIG. 25. The Operating System cockpit shows the status of parameters that are specific to the operating system level of a monitored system 14. All parameters are found within SAP or the operating system and are accessed or repaired from either the operating system level or from SAP. The Operating System cockpit shows a graph of the CPU utilization by server for the last 24 hours and also shows the current operating system status with the “stop light.” By clicking on the current Operating System status link, the productivity center 10 provides the status of individual parameters within the Operating System cockpit, such as through the interface shown in FIG. 26. The parameters shown in FIG. 26 include some red and yellow parameters, which means the current operating system status shown in FIG. 25 is depicted with the color red. If a user clicks on a colored status block of one of the red or yellow parameters, the productivity center 10 displays a graph showing the values for that particular parameter over the last 24 hours. An example of such a graph is shown in FIG. 27. The underlying statistical data used in producing the graphs may be accessed through the Reports cockpit, which will be described in more detail below.

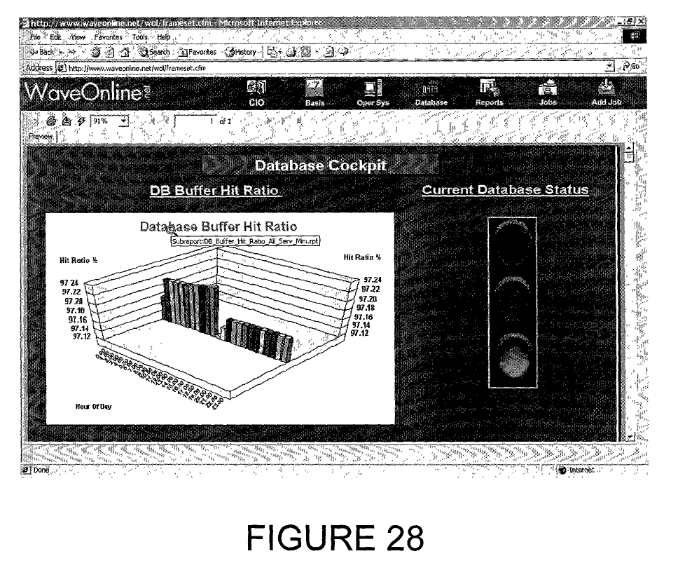

An example of a Database cockpit is shown in FIG. 28. The Database cockpit shows the database buffer hit ratio over the last 24 hours in graph form and also shows the current data base status with a stop light. The database cockpit shows the status of parameters that are specific to the database level of the monitored system 14. All parameters are found within SAP, the operating system level, or through the database itself and are accessed or repaired from either the operating system level or from SAP.

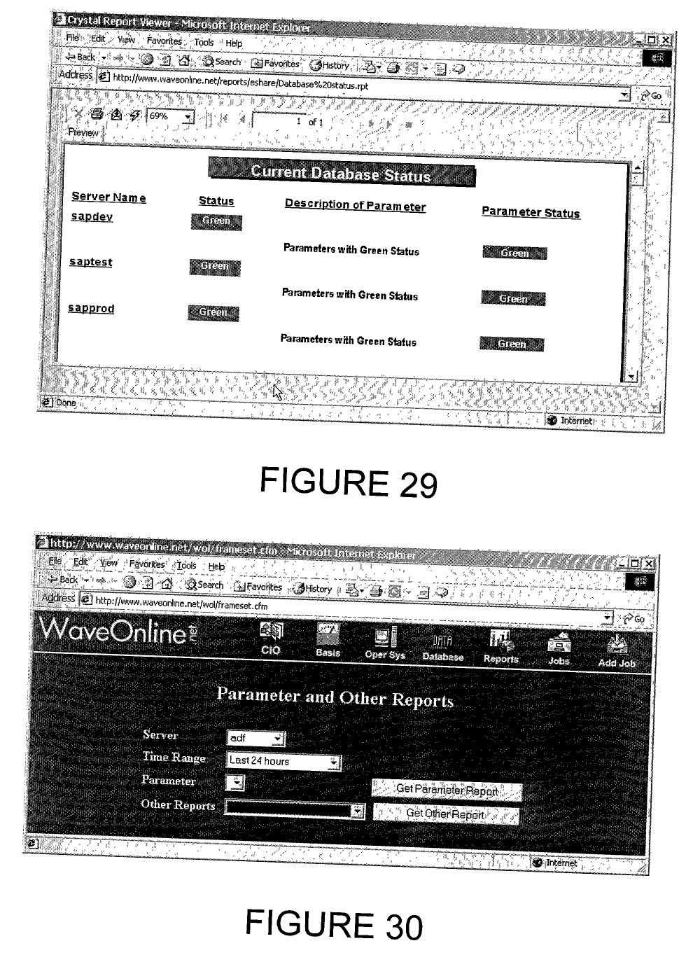

As with the other cockpits, when a user selects the “Current Database Status” link, the productivity center 10 displays the status of individual parameters under the Database cockpit. FIG. 29 provides an example of an interface showing the status of parameters in the Database cockpit, with all of the parameters being shown as green. When clicking on one of the blocks shown in FIG. 29, the productivity center 10 displays a list of all of the associated parameters.

An example of a Reports cockpit is shown in FIG. 30. The Reports cockpit gives access to a graph for every parameter through a parameter drop-down list. The Reports cockpit also gives access to some specialized reports through an “Other Reports” drop-down list for various time ranges. The time ranges in the preferred embodiment are over the last 24 hours, last 30 days, a monthly report, or a user-specified date range.

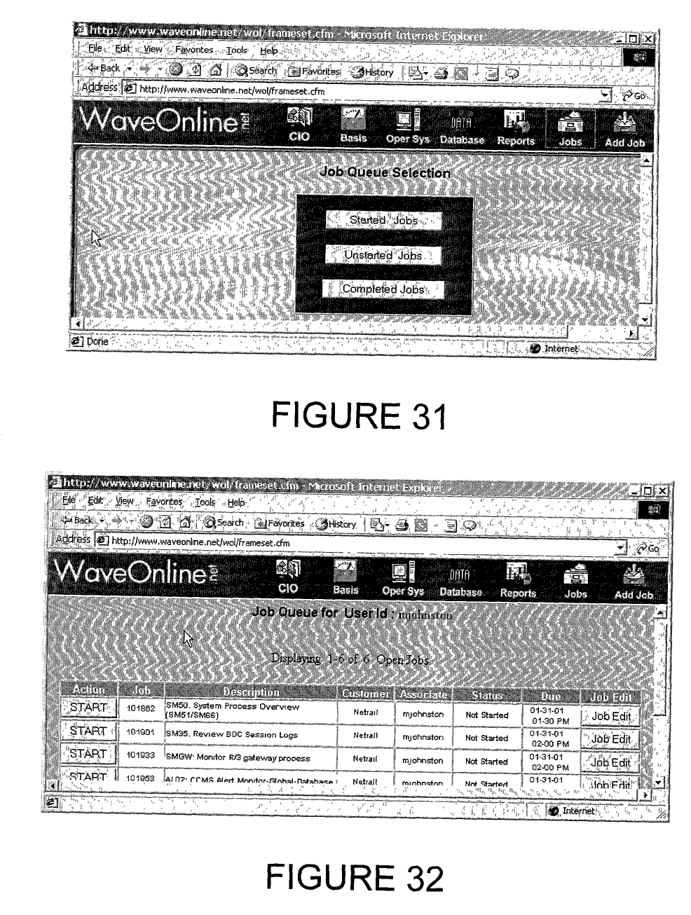

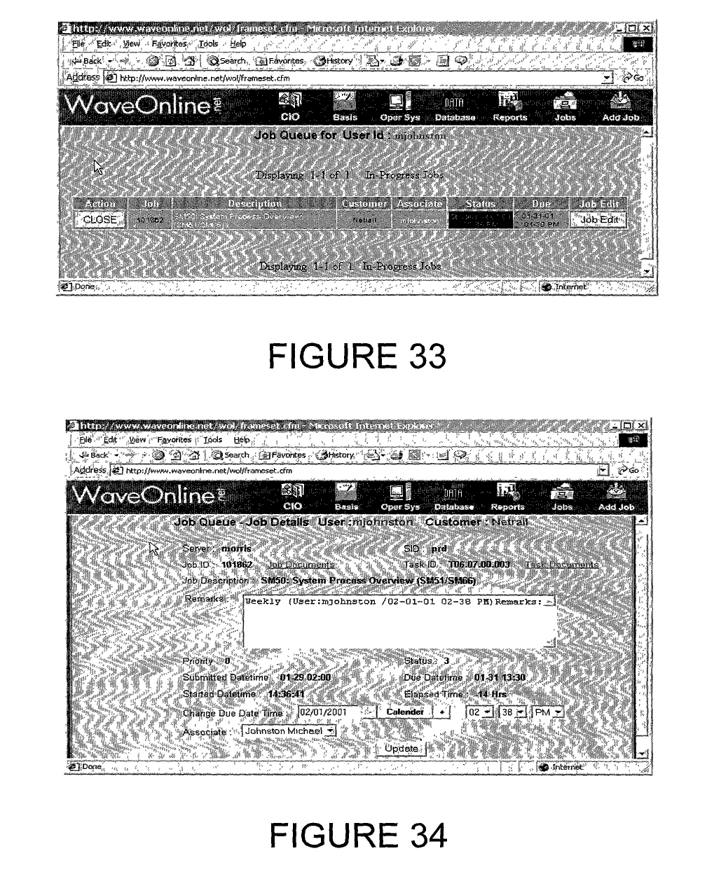

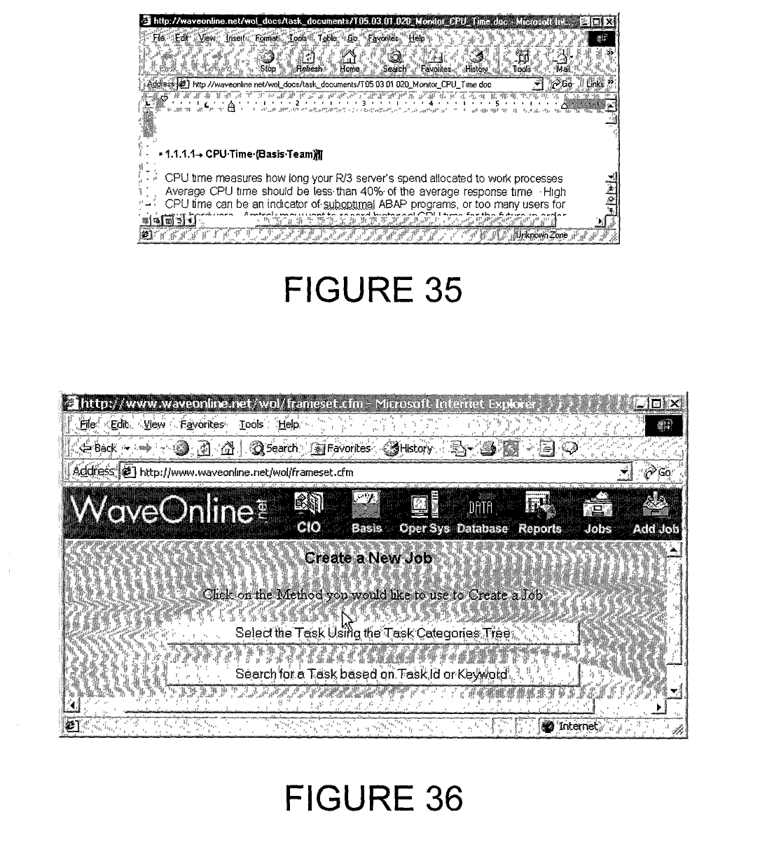

FIG. 31 shows an example of a Jobs cockpit where the user, such as the CIO, can view started jobs, unstarted jobs, and completed jobs. FIG. 32 provides an example of an interface showing the unstarted jobs which are waiting in the job queue. Once a job has started, the job queue removes that job from the unstarted job screen. FIG. 33 provides an example of a list of started jobs. Once a job is performed, the associate closes the job in the job queue, which causes the job to be removed from the queue and causes the data in the database to be updated. If a job is left unstarted, the productivity center 10 continues to escalate the job to other associates until the work is completed. By selecting the “Job Edit” button from the interface shown in FIG. 33, the productivity center 10 displays job details that are not available on the job queue screen, such as the details shown in FIG. 34. The interface shown in FIG. 34 allows an associate to enter remarks on any issue that arises while working on a job. When the associate is finished, the associate selects the “Update” button to capture the remarks. The interface shown in FIG. 34 also includes a task link “Task Documents” which allows the associate to receive instructions on how to perform the job. FIG. 35 provides an example of some sample instructions displayed by the productivity center 10 to the associate upon selecting the task link.

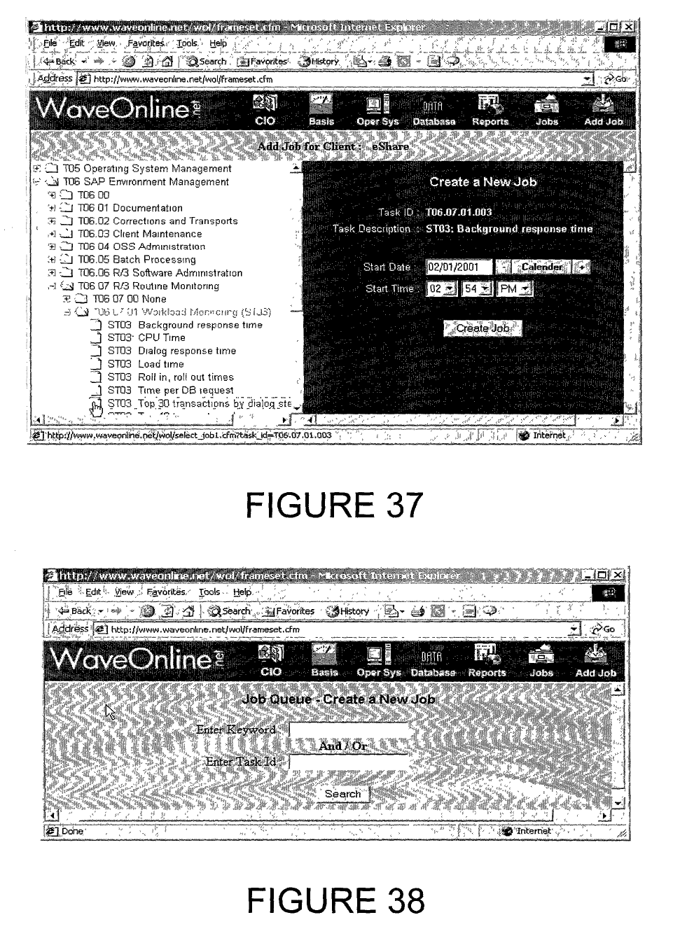

Periodically, it may be necessary to create a new job, such as one based on an event driven situation to support a monitored system 14. To create a new job, a user selects the “Add Job” button and receives an interface such as shown in FIG. 36. The productivity center 10 provides at least two options on adding a task, with one choice being “Select The Task Using The Task Categories Tree.” By selecting this option, the user is presented with the interface shown in FIG. 37 where the user can browse through the available task tree for their particular client and chose a specific job needed with the desired date and start time. The second choice is available when the user knows what job they would like to add. By selecting the “Search For A Task Based On Task ID or Key Word” button, the user is presented with the interface such as the one shown in FIG. 38. Through this interface, the user can search by keyword or by task ID.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What we claim:

1. A method of providing remote support to a monitored system, comprising:
providing a remote productivity center connected to the monitored system, the monitored system having at least one agent for gathering data;
receiving data from the agent at the monitored system;
comparing the data from the monitored system with threshold values;
ascertaining jobs to be performed on the monitored system as a result of the comparing;
identifying a first set of the jobs and automatically performing work required to complete the first set of jobs through the productivity center; and
identifying a second set of the jobs and assigning the jobs to associates for manually performing work required to complete the second set of jobs.

2. The method as set forth in claim 1, wherein assigning jobs to associates comprises scheduling the second set of tasks to the associates.

3. The method as set forth in claim 2, wherein scheduling comprises assigning jobs to associates based on associates assigned to the monitored system.

4. The method as set forth in claim 2, wherein scheduling comprises assigning jobs based on required skill level of the jobs and skill level of the associates.

5. The method as set forth in claim 2, wherein scheduling includes allocating the second set of jobs to the associates based on at least one factor selected from the group comprising: work level of the associates, availability of the associates, monitored system associated with the associates, and a desire for the second set of jobs to be assigned to associates having the lowest skill level.

6. The method as set forth in claim 1, wherein receiving data comprises receiving requests for jobs to be performed.

7. The method as set forth in claim 1, wherein receiving data comprises receiving performance data from a server within the monitored system.

8. The method as set forth in claim 1, wherein automatically performing the second set of jobs comprises instructing the agents at the monitored system to perform the work required to complete the first set of jobs.

9. The method as set forth in claim 1, wherein ascertaining jobs to be performed comprises providing a task dictionary defining tasks that may need to be performed on the monitored system.

10. The method as set forth in claim 1, further comprising providing status information on the monitored system.

11. The method as set forth in claim 10, wherein providing status information comprises providing status information to wireless devices.

12. The method as set forth in claim 10, further comprising providing alerts regarding the status information on the monitored system.

13. The method as set forth in claim 1, further comprising tracking availability of the associates.

14. A productivity center for providing remote support to a monitored system, comprising:
a message broker for receiving data from the monitored system;
a solution engine for receiving the data from the message broker, for comparing the data with threshold values, and for ascertaining jobs to be performed on the monitored system;
a scheduling engine for receiving a first set of jobs from the solution engine and for remotely performing required to complete the first set of jobs;
wherein the solution engine assigns a second set of the jobs to associates for performing work required to complete the second set of jobs.

15. The productivity center as set forth in claim 14, further comprising a calendar tool for tracking an availability of the associates.

16. The productivity center as set forth in claim 14, wherein the solution engine derives status information on the monitored system from the data and wherein the system further comprises an escalation engine for sending notifications with the status information.

17. The productivity center as set forth in claim 16, wherein the escalation engine sends notifications to wireless devices.

18. The productivity center as set forth in claim 14, wherein the solution engine comprises a pre-processor for obtaining information from a job queue, a solver for assigning the jobs to the scheduling engine and to the associates, and a post-processor for sending job assignments to the scheduling engine and for updating the job queue.

19. The productivity center as set forth in claim 14, further comprising a task dictionary of tasks that may need to be performed on the monitored system, the task dictionary being stored in a jobs database.

20. The productivity center as set forth in claim 16, further comprising an interface for providing access to the status information and to the data received from the monitored system.
